(19) United States
(12) Patent Application Publication
(10) Pub. No.: US 2026/0346536 A1
(43) Pub. Date: Nov. 5, 2026

(54) SCREEN PROTECTOR INSTALLATION SYSTEM

(71) Applicant: ZAGG Inc, Midvale, UT (US)

(72) Inventors: Jordan Melville, Sandy, UT (US); Cory Pymm, Salt Lake City, UT (US); Konstantin Belyaev, South Jordan, UT (US); Michael Jenson, Riverton, UT (US); Gang Fu, Shenzhen (CN)

(73) Assignee: ZAGG Inc, Midvale, UT (US)

(21) Appl. No.: 19/662,471

(22) Filed: Apr. 29, 2026

Related U.S. Application Data
(60) Provisional application No. 63/797,582, filed on Apr. 30, 2025.

(51) Int. Cl. B29C 63/00

(52) U.S. Cl. CPC B29C 63/0004; B29C 63/0047; B29C 2063/0008

(57) ABSTRACT

A screen protector installation system includes a tray assembly and a screen protector assembly. The tray assembly includes a first tray portion including a first projection defining a first locating plane configured to abut an edge of a handheld device and a second tray portion including a second projection defining at least one second locating plane configured to abut an end of the handheld device. The screen protector assembly includes a screen protector having an adhesive layer and a liner removably coupled to the adhesive layer, a cap sheet removably coupled to the screen protector, a screen protector keying feature coupled to the cap sheet configured to engage the tray keying feature, and a pull tab coupled to a coupling end of the liner. Pulling the pull tab peels the liner off the adhesive layer, exposing the adhesive layer.

### BACKGROUND

Handheld devices include screens (e.g., display screens, touch screens, etc.) susceptible to damage from scratches, impacts, and fingerprints, all of which can degrade both the visual appearance and usability of the handheld device. Screens that come in a variety of sizes, shapes, and designs, with differences in bezel thickness, edge curvature, and screen aspect ratios. Screen protectors, typically made from materials like plastic film or tempered glass, are commonly used to safeguard the screens of these handheld devices.

However, the installation (e.g., application, placement, adhering, etc.) of screen protectors remains a challenging task for users. A major difficulty in the installation process is achieving proper alignment of the screen protector to the screen during installation. For example, the screen protector may shift or misalign before fully adhering to the screen. Misalignment of the screen protector can cause undesirable effects, such as air bubbles, visible edges, and the like. Failure to properly install the screen protector not only affects the overall appearance of the screen protector but can also compromise the effectiveness of the screen protector, as misaligned screen protectors may not provide complete coverage and/or protection.

To address this issue, some screen protectors come with installation tools (e.g., frames, trays, or guides) to facilitate positioning the screen protector properly. These installation tools are typically designed for specific models or specific screen sizes/shapes, and/or tailored to the exact dimensions of a single handheld device, and cannot accommodate a range of screen sizes, shapes, and/or designs. Although intended to improve the installation process, these installation tools can be cumbersome and difficult for users to use, resulting in improper installation of the screen protector. Further, these installation tools can create unnecessary waste. For example, as users obtain new handheld devices, they must install a new screen protector using a different installation tool specific to that new handheld device. As such, there is a need for a user-friendly universal screen protector installation system that can accommodate various handheld devices and ensure proper alignment of screen protectors.

### SUMMARY

In one embodiment, a screen protector installation system for a handheld device includes a tray assembly defining a longitudinal axis and having a first peripheral edge at a first end and a second peripheral edge at a second end opposite the first end. The tray assembly includes a first tray portion disposed at the first end including a first projection extending from the first peripheral edge defining a first locating plane configured to abut an edge of the handheld device, a second tray portion disposed at the second end including a second projection extending from the second peripheral edge defining at least one second locating plane configured to abut an end of the handheld device opposite the edge, a tray keying feature, and a slot extending through a wall of one of the first projection or the second projection. The first tray portion and the second tray portion are configured to telescope along the longitudinal axis. The first locating plane and the second locating plane define a hollow region within the tray assembly configured to align the handheld device. The screen protector installation system includes a screen protector assembly configured to be received within the tray assembly. The screen protector assembly includes a screen protector having an adhesive layer configured to attach to a screen of the handheld device and a liner removably coupled to the adhesive layer, a cap sheet removably coupled to the screen protector opposite the liner, a screen protector keying feature coupled to the cap sheet configured to engage the tray keying feature and align the screen protector assembly to the tray assembly, and a pull tab coupled to a coupling end of the liner configured to extend longitudinally over the liner and through the slot of the tray assembly. Pulling the pull tab through the slot peels the liner off the adhesive layer, exposing the adhesive layer.

In one embodiment, a screen protector installation system for a handheld device includes a tray assembly defining a longitudinal axis and having a first peripheral edge at a first end and a second peripheral edge at a second end opposite the first end. The tray assembly includes a first tray portion disposed at the first end including a first projection extending from the first peripheral edge defining a first locating plane configured to abut an edge of the handheld device, a second tray portion disposed at the second end including a second projection extending from the second peripheral edge defining a second locating plane configured to abut an end of the handheld device opposite the edge, a tray keying feature, and a slot extending through a wall of one of the first projection or the second projection. The first locating plane and the second locating plane define a hollow region within the tray assembly to align the handheld device. The first tray portion and the second tray portion are configured to telescope along the longitudinal axis. One of the first tray portion or the second tray portion is slidingly moveable along a length of the other of the first tray portion or the second tray portion to adjust a size of the hollow region. The screen protector installation system includes a screen protector assembly, including a screen protector having an adhesive layer configured to attach to a screen of a handheld device and a liner removably coupled to the adhesive layer, a cap sheet removably coupled to the screen protector opposite the liner, a screen protector keying feature configured to engage the tray keying feature and align the screen protector assembly to the tray assembly, and a pull tab coupled to a coupling end of the liner configured to extend longitudinally over the liner and through the slot. Pulling the pull tab through the slot peels the liner off the adhesive layer, exposing the adhesive layer.

In one embodiment, a screen protector installation system for a handheld device includes an outer container including side walls defining an opening and a cavity and a tray assembly disposed within the cavity defining a longitudinal axis and having a first peripheral edge at a first end and a second peripheral edge at a second end opposite the first end. The tray assembly includes a first tray portion disposed at the first end including a first projection extending from the first peripheral edge defining a first locating plane configured to abut an edge of the handheld device when the handheld device is in an aligned position, a second tray portion disposed at the second end including a second projection defining a second locating plane configured to abut an end of the handheld device opposite the edge when the handheld device is in the aligned position. One of the first tray portion or the second tray portion is a moving tray and the other of the first tray portion or the second tray portion is a stationary tray. The tray assembly includes a tray keying feature and a slot extending through a wall of the moving tray and configured to be positioned opposite the opening. The first projection and the second projection define a hollow region within the tray assembly configured to receive and align the handheld device. The moving tray is slidingly moveable relative to the stationary tray along the longitudinal axis along a length of the stationary tray. The screen protector installation system includes a screen protector having an adhesive layer configured to attach to a screen of a handheld device and a liner removably coupled to the adhesive layer, a cap sheet removably coupled to a surface of the screen protector opposite that to which the liner is removably coupled, a screen protector keying feature coupled to the cap sheet and configured to engage the tray keying feature and align the screen protector assembly to the tray assembly, and a pull tab coupled to the liner at a coupling end configured to be positioned adjacent the opening. The pull tab is configured to extend longitudinally over the liner, through the slot, beneath the tray assembly, and out through the opening. Pulling the pull tab through the opening draws the moving tray towards the stationary tray along the longitudinal axis against the handheld device until the handheld device is in the aligned position. When the handheld device is in the aligned position, the pull tab is configured to be pulled through the opening to peel the liner off the adhesive layer, exposing the adhesive layer.

### BRIEF DESCRIPTION OF DRAWINGS

The accompanying drawings, which are included to provide further understanding and are incorporated in and constitute a part of this specification, illustrate disclosed embodiments and together with the description explain the principles of the disclosed embodiments. In the drawings:

FIG. 1 is a schematic diagram of a screen protector installation system, according to a first embodiment of the present disclosure;

FIG. 2 is a front right perspective view of a screen protector installation system and a handheld device, according to a second embodiment of the present disclosure;

FIG. 3 is a cross-sectional view of the screen protector installation system of FIG. 2, with the handheld device positioned and the outer container in an enclosed position;

FIG. 4 is an exploded view of the screen protector installation system of FIG. 2;

FIG. 5 is a front right perspective view of a tray assembly of the screen protector installation system of FIG. 2;

FIG. 6 is a top plan view of the tray assembly of the screen protector installation system of FIG. 2;

FIG. 7 is a top plan view of the screen protector installation system of FIG. 2 and a handheld device, with the lid removed;

FIG. 8 is a bottom right perspective view of the screen protector assembly of the screen protector installation system of FIG. 2;

FIG. 9 is a front right perspective view of a screen protector installation system and a handheld device, according to a third embodiment of the present disclosure;

FIG. 10 is a top right perspective view of the screen protector assembly of the screen protector installation system of FIG. 9;

FIG. 11 is a top plan view of a handheld device and the screen protector installation system of FIG. 9, with the lid removed and the handheld device in an unaligned position;

FIG. 12 is a cross-sectional view of FIG. 11;

FIG. 13 is a top plan view of a handheld device and the screen protector installation system of FIG. 9, with the lid removed and the handheld device in an aligned position;

FIG. 14 is a cross-sectional view of FIG. 13;

FIG. 15 is a top plan view of a handheld device and the screen protector installation system of FIG. 9, with a portion of the liner peeled from the adhesive layer;

FIG. 16 is a cross-sectional view of FIG. 15;

FIG. 17 is a front right perspective view first tray portion and a lid of a screen protector installation system, according to some embodiments of the present disclosure;

FIG. 18 is a top plan view of the first tray portion and the lid of FIG. 17;

FIG. 19 is a front right perspective view first tray portion and a lid of a screen protector installation system, according to some embodiments of the present disclosure;

FIG. 20 is a top plan view of the first tray portion and the lid of FIG. 19;

FIG. 21 is a front right perspective view of a tray keying feature of a screen protector installation system, according to some embodiments of the present disclosure;

FIG. 22 is a top plan view of the tray keying feature of FIG. 20;

FIG. 23 is a front perspective view of a screen protector keying feature of a screen protector installation system complementary to the tray assembly of FIG. 21, according to some embodiments of the present disclosure;

FIG. 24 is a top plan view of the screen protector keying feature of FIG. 23; and

FIG. 25 is a top plan view of the tray assembly of FIG. 20 and the screen protector keying feature of FIG. 23 engaged together.

In one or more implementations, not all of the depicted components in each figure may be required, and one or more implementations may include additional components not shown in a drawing figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various ways, all without departing from the scope of the present disclosure. Accordingly, the drawings and description are to be regarded as illustrative in nature and not restrictive.

The term “handheld device” is used herein to refer to a portable/mobile handheld electronic device having a screen (e.g., smartphones, tablets, E-readers, smartwatches, portable gaming consoles, handheld media players, portable video players, etc.).

The terms “screen” and “device screen” are used interchangeably herein to describe a display screen on a handheld device. Generally, the display screen is a touch screen that receives input through touch (e.g., pinch-to-zoom, gestures, swipe, click, multi-touch, etc.).

The term “screen protector” is used herein to refer to a thin layer designed to protect a screen from scratches, smudges, and/or impact. The screen protector can also reduce glare or provide privacy. The screen protector may include one or more layers, such as a protective glass (e.g., tempered glass, etc.) layer or plastic (e.g., polyethylene terephthalate (PET), thermoplastic polyurethane (TPU), etc.) layer, a shock absorption layer, and an adhesive layer (e.g., a silicone-based adhesive, an acrylic adhesive, etc.) to adhere/affix the protective layer to the screen of the handheld device. The screen protector may include additional coatings (e.g., oleophobic coatings, etc.) applied to the protective layer. A release liner (e.g., a protective film, etc.), typically made of a thin plastic sheet, may be provided to cover the adhesive layer until the screen protector is ready to be applied to the screen of the handheld device. A cap sheet (e.g., a backing layer, etc.) may be provided to protect the protective layer from scratches and dust prior to installation of the screen, such as during manufacturing and shipping. The cap sheet may be made of a thin plastic, paper, or thin foil. The screen protector may be transparent such that the display screen can be viewed through the screen protector without obstruction. The screen protector can maintain the touch sensitivity of the display screen without lag or interference. The screen protector may be disposed directly on the display screen, and cover a portion of, or an entirety of the display screen. The screen protector may have a shape that substantially matches the shape of the handheld device to which it is being attached. The screen protector may also include notches, cut-outs, and openings to accommodate components of the handheld device (e.g., camera lens, speaker, button, etc.)

The terms “installation,” or “installation process” are used herein to refer to the process (e.g., procedure, steps, sequence, etc.) of applying a screen protector to device screen. Generally, the installation process for applying a screen protector to a device screen includes positioning, or aligning, a screen protector and a device screen, and removing a liner to expose an adhesive layer of the screen protector, where the adhesive layer serves to bond the screen protector to the device screen.

The present disclosure is directed to a screen protector installation system capable of aligning a handheld device for installation of a screen protector and facilitating application of the screen protector onto a device screen. The screen protector installation system includes a two-part tray assembly and a screen protector assembly. The screen protector assembly is received within the tray assembly and keyed into the tray assembly to prevent rotation and align the screen protector assembly to the tray assembly. A handheld device can be placed into the tray assembly with the device screen facing the screen protector assembly.

The tray assembly includes a first tray portion defining a first substantially vertical locating plane and a second tray portion defining a second substantially vertical locating plane at an opposite end of the tray assembly. The first tray portion and the second tray portion can be positioned to overlap each other, and are slidably movable with respect to each other, or can otherwise telescope, along a longitudinal axis of the tray assembly. The first locating plane and the second locating plane define a hollow region therebetween that receives and aligns the handheld device within the tray assembly. The handheld device is aligned within the tray assembly by the first locating plane abutting an edge of the handheld device and the second locating plane abutting an end of the handheld device opposite the edge of the handheld device abutting the first locating plane. Accordingly, the handheld device (and therefore, the device screen) is aligned with the screen protector assembly.

The screen protector assembly includes a screen protector having an adhesive layer that adheres (e.g., affixes, bonds, attaches, secures, etc.) the screen protector onto the device screen and a liner removably attached to the adhesive layer. The liner is coupled to a pull tab at a coupling end of the liner. The pull tab is configured to fold over the liner, with a free end of the pull tab extending through a slot in the tray assembly opposite the coupling end. The pull tab facilitates removal of the liner. As the pull tab is pulled through the slot, the pull tab peels (e.g., removes, delaminates, etc.) the liner off the adhesive layer and back onto itself, thereby exposing the adhesive layer disposed between the screen protector and the liner. As the handheld device is positioned above the screen protector, through natural gravitational pull, the handheld device falls, or drops, onto the adhesive layer, and applies the screen protector onto the device screen. Alternatively, while the liner is being peeled off the adhesive layer, a force or pressure can be applied to a back face of the handheld device opposite the device screen, in a direction toward the screen protector, to drive the device screen into contact with the adhesive layer and apply the screen protector to the device screen.

Embodiments described herein can be used to accommodate a range of handheld devices having different sizes and shapes. One tray portion can slidingly move along a length of the other tray portion to adjust the size of the hollow region. Thus, the tray assembly can be used for alignment across multiple handheld devices. For example, the tray assembly can be arranged in a set position (e.g., using a jig with dimensions associated with a particular handheld device, using a stepped locking system or stops at pre-set dimensions between the first tray portion and the second tray portion, etc.) for use with a selected handheld device. To use the tray assembly with a different selected handheld device, one tray portion can be slidingly moved along a length of the other tray portion to a different set position to change the size of the hollow region for use with the different selected handheld device. For example, a fixed tray portion can be molded into an outer container, and an adjustable tray portion can be positioned relative to the fixed tray portion to adapt the tray assembly for different handheld devices. The adjustable tray may be shared across different devices or configured for a specific handheld device. The shared use of the tray assembly across multiple handheld devices allows the screen protector installation system to be universal (e.g., adaptable, compatible, etc.), and provides cost savings, improves manufacturing efficiency and quality control, and reduces waste.

In some embodiments, one tray portion is a stationary tray, and the other tray portion is a moving tray. The moving tray can slidingly move along a length of the stationary tray. In use, the handheld device is placed between the moving tray and the stationary tray. There may be clearance between the handheld device and at least one of the stationary tray and the moving tray. The pull tab can be configured to fold over the liner, extend through the slot in the tray assembly, and route back and under and out from the tray assembly. As the pull tab is pulled, the pull tab draws the moving tray towards the stationary tray and against the handheld device. The moving tray clamps (e.g., press, grip, squeeze, holds, etc.) down on the handheld device, sandwiching the handheld device between the moving stray and the stationary tray, and orients the handheld device until the handheld device is in an aligned position within the tray assembly (e.g., a first locating plane abuts an edge of the handheld device and a second locating plane abuts an end of the handheld device opposite the edge). Thus, the tray assembly does not require discrete adjustments (e.g., fixed steps, predetermined positions, predetermined measurements, discrete stopping points, defined increments, etc.) to align and secure a given handheld device, as pulling the pull tab allows continuous adjustments as the moving tray travels along the length of the stationary tray. Continuous adjustment allows for more flexibility to accommodate a wider range of handheld devices. Additional force provided by the user pulling the pull tab further aids in clamping down on the handheld device to further secure and align the handheld device.

Further, embodiments described herein can be used to apply screen protectors onto handheld devices, in an easier and more reliable manner. The screen protector assembly is pre-positioned within the tray assembly. A user places the handheld device into the tray assembly atop the screen protector assembly and pulls a free end of the pull tab through the slot. The slot aids in guiding and aligning the pull tab as it is pulled. In one motion, the liner is removed from the adhesive layer, the handheld device drops onto the adhesive layer, and the screen protector affixes to the device screen. Reducing the number of steps and movements required to install the screen protector reduces risk of user error in the installation process and provides accessibility to a wider range of users with varying abilities. The features of the embodiments described herein can also reduce the possibility of misalignment of the handheld device and the screen protector. Proper alignment between the handheld device (in particular, the screen) and the screen protector assembly (in particular, the screen protector) is dependent upon how accurately the tray assembly is aligned to the screen protector assembly and the handheld device. The screen protector assembly is keyed to the tray assembly, preventing rotation or shifting of the screen protector assembly with respect to the tray assembly. Therefore, there is more precise alignment between the tray assembly and the screen protector assembly, as relative motion is restricted. The first locating surface and the second locating surface of the tray assembly are self-aligning features that help guide and automatically align the handheld device within the tray assembly and restrict motion in multiple directions, keeping the handheld device in proper alignment. Therefore, there is more precise alignment between the tray assembly and the handheld device. As deviations between the alignment of the tray assembly and the screen protector and the alignment of the handheld device and the tray assembly are reduced, accumulated (e.g., stacked, etc.) misalignment can be reduced, resulting in more precise alignment between the device screen and the screen protector.

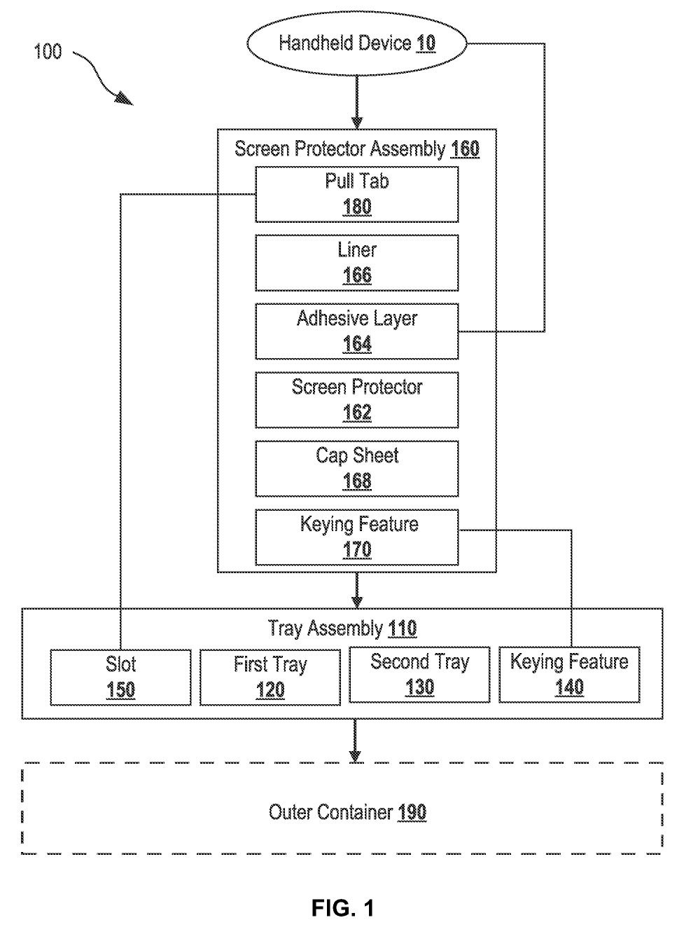

Referring to FIG. 1, a schematic of a screen protector installation system 100 is shown, according to some embodiments. The screen protector installation system 100 is configured to align a handheld device 10 and facilitate installation of a screen protector onto a screen of a handheld device 10. In particular, the screen protector installation system 100 is configured to align the device screen and the screen protector and enable a user to easily apply the screen protector to the screen. The screen protector installation system 100 includes a tray assembly 110 and a screen protector assembly 160. Optionally, the screen protector installation system 100 includes an outer container 190.

The tray assembly 110 includes a first tray portion 120, a second tray portion 130, a tray keying feature 140, and a slot 150. The tray assembly 110 forms a base (e.g., a foundation, a platform, etc.) of the screen protector installation system 100. The tray assembly 110 is configured to receive and align the screen protector assembly 160. The tray assembly 110 is also configured to receive, hold (e.g., position, support, retain, secure, etc.), and align the handheld device 10. In use, the screen protector assembly 160 is pre-positioned into the tray assembly 110 prior to installation. A user places the handheld device 10 into the tray assembly 110 above the screen protector assembly 160. In some embodiments, the tray assembly 110 may be formed of a rigid material (e.g., cardboard, paper pulp, polystyrene, acrylonitrile butadiene styrene (ABS), polypropylene (PP), polyvinyl chloride (PVC), polyethylene (PE), etc.). In some embodiments, the tray assembly 110 is formed by die-cutting, injection molding, thermoforming, extrusion forming, and/or 3D printing (e.g., fused deposition modeling (FDM), stereolithography (SLA), selective laser sintering (SLS), etc.).

The first tray portion 120 and the second tray portion 130 define a level surface to support and horizontally align the screen protector assembly 160 and the handheld device 10. An upper surface of the first tray portion 120 is substantially coplanar with an upper surface of the second tray portion 130. The upper surface of the first tray portion 120 and the upper surface of the second tray portion 130 together form a seat configured to support/stabilize the screen protector assembly 160 and the handheld device 10 stacked above the screen protector assembly 160. The upper surface of the first tray portion 120 and the upper surface of the second tray portion 130 may be adjacent or may be spaced apart. The seat serves as horizontal reference plane for the screen protector installation system 100 that ensures that the screen protector assembly 160 and the handheld device 10 are stacked evenly and provides a stable, level surface to prevent shifting or tilting of the screen protector assembly 160 and/or the handheld device 10.

The first tray portion 120 and the second tray portion 130 also include raised features (e.g., walls, projections, protrusions, ridges, bumps, etc.) at distal ends of the tray assembly 110 that constrain the border of the handheld device 10 within the tray assembly 110. The raised features form points of contact between the tray assembly 110 and the border of the handheld device 10. The raised features form a hollow region (e.g., a recess, a cavity, depression, etc.) to receive and align the handheld device 10. The first tray portion 120 and the second tray portion 130 are configured to abut (e.g., touch, adjoin, contact, etc.) opposite ends of the handheld device 10 and align the handheld device 10 within the tray assembly 110. In some embodiments, the first tray portion 120 may define a planar surface configured to abut an edge of the handheld device 10, and the second tray portion 130 may define a planar surface configured to abut an end of the handheld device 10 opposite the edge of the handheld device 10.

The first tray portion 120 and the second tray portion 130 are configured to telescope along a longitudinal axis of the tray assembly 110. One tray portion is inserted inside the other tray portion (e.g., nested), or alternatively a section of one tray portion slidingly overlaps a section of the other tray portion, allowing for adjustable length of the tray assembly 110. In some embodiments, one of the first tray portion 120 and the second tray portion 130 is slidingly moveable along a length of the other. The first tray portion 120 and the second tray portion 130 can be moved relative to one another to different set positions to adjust a size of the hollow region for use with different handheld devices. For example, the first tray portion 120 and the second tray portion 130 can be set apart from one another in a selected position using a jig that is designed for a specific handheld device. The first tray portion 120 and the second tray portion 130 may be affixed in the selected position by adhering the first tray portion 120 and the second tray portion 130 together and/or the first tray portion 120 and the second tray portion 130 may be adhered to the outer container 190. In some embodiments, one of the first tray portion 120 or the second tray portion 130 may be molded into the outer container 190, and the other may be adhered to the outer container 190.

The tray keying feature 140 is configured such that the screen protector assembly 160 can be positioned in the tray assembly 110 and engage the tray keying feature 140 to align the screen protector assembly 160. The tray keying feature 140 prevents relative movement between the screen protector assembly 160 and the tray assembly 110 and ensures proper alignment between the tray assembly 110 and the screen protector assembly 160. The tray keying feature 140 may be provided on at least one of the first tray portion 120 and the second tray portion 130. In some embodiments, the tray keying feature 140 is a female keying feature that includes a receiving component such as a cavity, recess, slot, groove, or hole. The female keying feature is configured to receive a corresponding male keying feature that matches the shape/size of the female keying feature. The male keying feature includes a protruding (e.g., external, projecting, etc.) component, such as a pin, peg, tab, rib, rail, bar, and the like. In some embodiments, one or more tray keying features 140 are provided within the tray assembly 110. The one or more tray keying features 140 may utilize similar and/or different keying mechanisms from one another, such as interlocking tabs, ridges and grooves, pins and holes, notches, tongue and groove, key holes and keys, snap-fit features, and the like. The one or more tray keying features 140 may also have similar and/or different shapes or sizes from one another.

The screen protector assembly 160 is received in the tray assembly 110. The screen protector assembly 160 is configured to align with the tray assembly 110 and enable a user to couple (e.g., install, attach, adhere, etc.) a protective layer to the device screen. In use, the screen protector assembly 160 is pre-positioned within the tray assembly 110 prior to installation. The handheld device 10 is placed on top of the screen protector assembly 160. The screen protector assembly 160 may have dimensions and features associated with the handheld device 10. For example, the screen protector assembly 160 may have dimensions substantially the same as the device screen, or the screen protector assembly 160 may have dimensions such that it covers a portion of the device screen. The screen protector assembly 160 includes a screen protector 162, an adhesive layer 164, a liner 166, a cap sheet 168, a pull tab 180, and a screen protector keying feature 170. In some embodiments, additional screen protector assemblies 160 can be provided for multiple installations using the screen protector installation system 100.

The screen protector 162 is the primary protective layer configured to bond to and protect the screen of the handheld device 10. The screen protector 162 may be at least one of tempered glass or plastic (e.g., PET, TPU, etc.). The screen protector 162 is configured to couple (e.g., attach, affix, bond, adhere, stick, etc.) to the device screen via the adhesive layer 164. The liner (e.g., a release liner, a backing layer, a protective backing etc.) 166 is removably coupled to the adhesive layer 164 to cover and protect the adhesive layer 164. The liner 166 is configured to be removed prior to installation. The cap sheet (e.g., a protective film, a top layer film, etc.) 168 is removably coupled to the screen protector 162 on a side opposite the liner 166 to protect an exposed surface of the screen protector 162. The cap sheet 168 is configured to be removed after installation.

The screen protector keying feature 170 is coupled (e.g., using adhesive, welding, fastened, snap fit, press fit, etc.) to the cap sheet 168 and is complementary to the tray keying feature 140. In some embodiments, the screen protector keying feature 170 is integrally formed with the cap sheet 168. The screen protector keying feature 170 is configured to engage the tray keying feature 140 and align the screen protector assembly 160 to the tray assembly 110. In some embodiments, the screen protector keying feature 170 and the tray keying feature 140 are secured/affixed to one another. For example, the screen protector keying feature 170 may be affixed to the tray keying feature 140 via an adhesive.

Many existing screen protector installation systems require alignment frames (e.g., guides, applicators, tools, etc.) that are installed (e.g., clip-on, snap-on, etc.) around the edges of a handheld device. The frame creates a physical boundary outside of the handheld device and the screen protector to align and guide installation of a screen protector onto a device screen. As frames take up space around the handheld device, they can be bulky and inconvenient to use. Further, producing a frame that fits around a handheld device, and is tailored to a specific handheld device, may not be cost-efficient. Advantageously, the screen protector keying feature 170 and the tray keying feature 140 of the screen protector installation system 100 are disposed within the outer peripheral boundary (e.g., a footprint) of the screen protector assembly 160, thereby requiring less material and space to align the screen protector assembly 160.

In some embodiments, the screen protector keying feature 170 is a male keying feature that includes a protruding (e.g., external, projecting, etc.) component, such as a pin, peg, tab, and the like, that fits into a corresponding female tray keying feature 140 matching the size/shape of the male keying feature. For example, the screen protector keying feature 170 can be a rib extending from a surface of the cap sheet 168 extending along a central longitudinal axis of the cap sheet 168, and the tray keying feature 140 may be a central channel (e.g., groove, slot, etc.) that the rib fits into. The channel provides a guide to align the rib accurately along a specific direction or plane and restricts lateral or angular movement of the rib, ensuring proper positioning and alignment of the screen protector assembly to the tray assembly 110. In some embodiments, one or more screen protector keying features 170 are coupled to the cap sheet 168. The screen protector keying features 170 may utilize similar and/or different keying mechanisms from one another, such as interlocking tabs, ridges and grooves, pins and holes, notches, tongue and groove, key holes and keys, snap-fit features, and the like. The one or more screen protector keying features 170 may also have similar and/or different shapes or sizes from one another. One or more of the screen protector keying features 170 may not engage a complementary keying feature in the tray assembly 110.

The pull tab 180 is coupled to the liner 166 at a coupling end and is configured to extend longitudinally over (e.g., fold back over) the liner 166 and extend through the slot 150 of the tray assembly 110. The slot 150 is provided on a distal end of the tray assembly 110 and extends through a wall of the first tray portion 120 or the second tray portion 130. The slot 150 is configured to guide a user’s motion during installation. The pull tab 180 is configured to be pulled through the slot 150 away from the coupling end to peel (e.g., remove, delaminate, etc.) the liner 166 off the adhesive layer 164 to install the screen protector 162. The pull tab 180 is configured to be accessible and easy to grip such that a user may easily grasp the pull tab 180. The pull tab 180 is pulled until the entire liner 166 is removed from the adhesive layer 164.The pull tab 180 and the liner 166 may then be disposed. The slot 150 provides a fixed path for the pull tab 180 to move through, ensuring that the pull tab 180 is aligned as it is pulled. The slot 150 therefore directs the movement of the pull tab 180 to be along a specific axis as it is pulled, preventing shifting and twisting, and therefore making the pulling motion more efficient and consistent. As the pull tab 180 is pulled through the slot 150, the tension applied to the liner 166 is evenly distributed ensuring the liner 166 is pulled smoothly from the adhesive layer 164, preventing the liner 166 from getting stuck, snagging, tearing, bunching, and/or folding over itself. Thus, the arrangement of the pull tab 180 and the slot 150 reduces the likelihood of mishandling and/or misaligning the liner 166 as it is removed during installation.

In some embodiments, the tray assembly 110 and the screen protector assembly 160 are disposed within an outer container 190. The outer container 190 may be made of cardboard, fiberboard, paper pulp, plastic, and the like. The outer container 190 includes sidewalls defining an opening and a cavity. The outer container 190 may have a shape and size similar to the tray assembly 110 such that an outer periphery of the tray assembly is disposed adjacent the sidewalls. The cavity is configured to receive the tray assembly 110, the screen protector assembly 160, and the handheld device 10. In some embodiments, one or more of the first tray portion 120 or the second tray portion 130 of the tray assembly 110 may be integrally formed with the outer container 190. For example, the first tray portion 120 may be molded into the outer container 190. A lid may be removably coupled to the outer container 190 and enclose the outer container 190 in a closed position. In some embodiments, the lid may be coupled to a portion of the tray assembly 110. A retaining member may be coupled to an inner surface of the lid that is configured to extend into the cavity and secure the handheld device 10 in the closed position. The retaining member applies pressure to the handheld device 10, holding the handheld device 10 in place during installation. The retaining member aids in maintaining the horizontal alignment of the tray assembly 110, screen protector assembly 160, and the handheld device 10, as well as preventing unwanted movement. In use, prior to installation, a user places the handheld device 10 into the outer container 190 and into the tray assembly 110 and closes the outer container 190 with the lid.

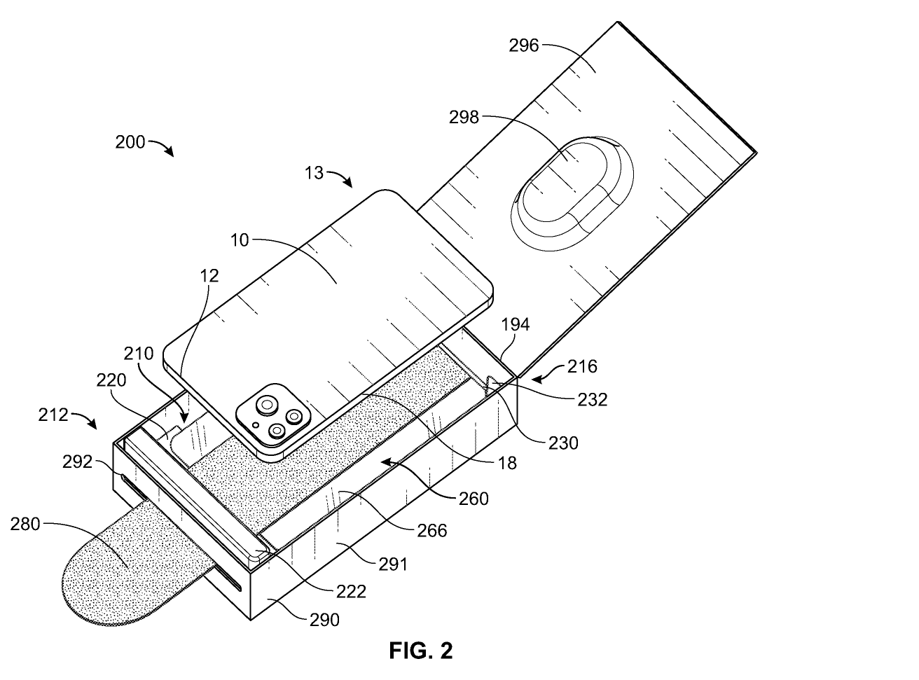

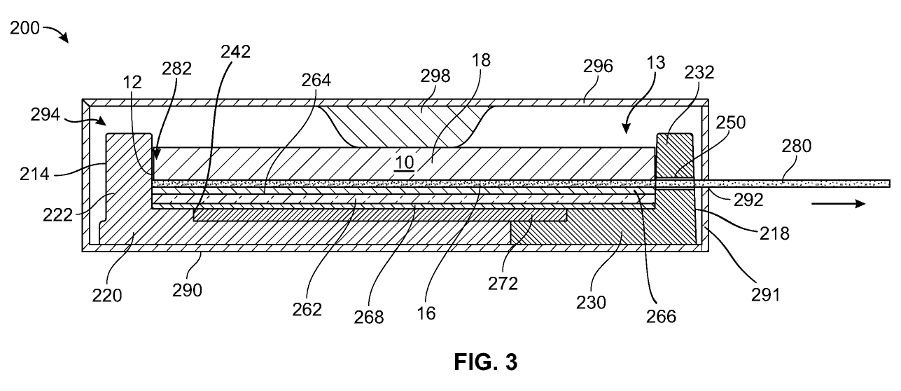

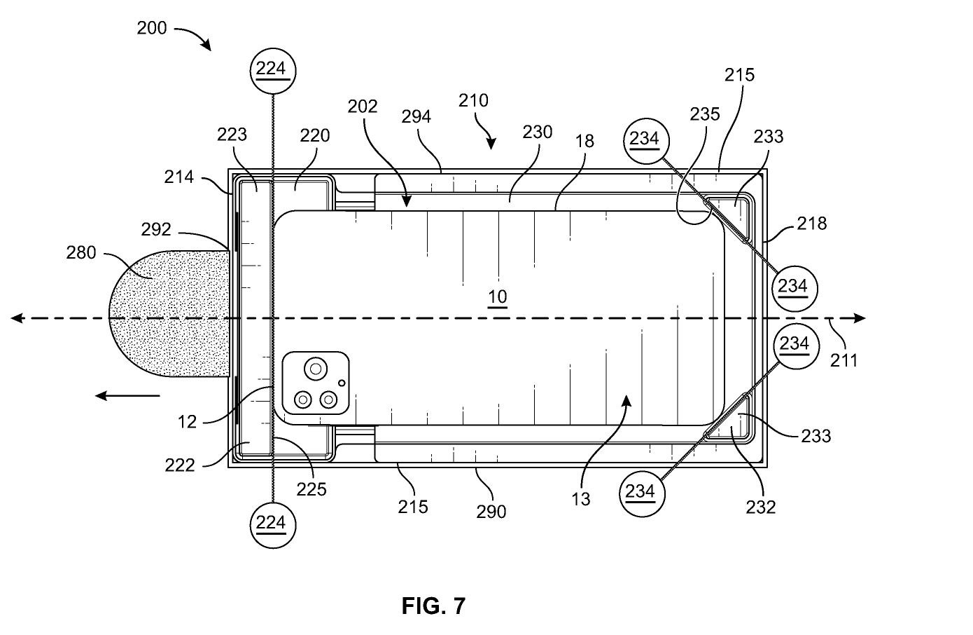

The tray assembly 110 and the screen protector assembly 160 can be arranged within the outer container 190 in a first configuration and/or a second configuration. In the first configuration, for example, as shown in FIGS. 2-8, the slot 150 of the tray assembly 110 is aligned with the opening (e.g. also configured as a complementary slot) defined in the outer container 190, and the screen protector assembly 160 is oriented such that the coupling end of the liner 166 is disposed at a location opposite the slot 150. For example, the opening in the outer container 190 may have substantially the same shape and dimensions as the slot 150 of the tray assembly 115, and when the tray assembly 110 is positioned within the outer container 190 such that the slot 150 of the tray assembly 115 and the opening of the outer container 190 are adjacent to one another, the slot 150 and the opening form one continuous opening. In the first configuration, the pull tab 180 is configured to extend longitudinally through the slot 150 and out through the opening. As the pull tab 180 is pulled outward through the opening and the slot 150, the liner 166 begins to peel away from the adhesive layer 164 at the coupling end of the liner 166 until the adhesive layer 164 is exposed. In the second configuration, the tray assembly 110 is disposed in the outer container 190 such that the slot 150 is disposed at a location opposite the opening defined in the outer container 190, and the screen protector assembly 160 is arranged such that the coupling end of the liner 166 is again disposed opposite the slot 150 defined in the tray assembly 110.

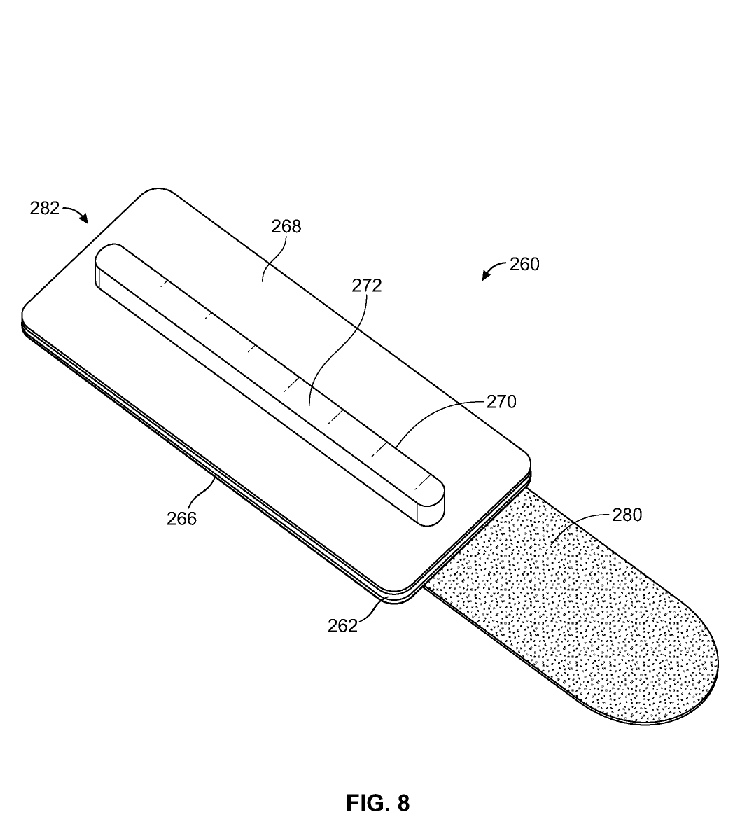

In the second configuration, for example, as shown in FIGS. 8-15, the pull tab 180 is configured to extend longitudinally through the slot 150, wrap back beneath the tray assembly 110, and exit the outer container 190 through the opening defined in the outer container 190. As the end of the pull tab 180 that is positioned exterior to the outer container 190 is pulled in a direction away from the outer container 190, to draw more of the length of the pull tab 180 outward from within the outer container 190 through the opening defined therein, the opposing end of the pull tab 180 within the outer container 190 is pulled through the slot 150 in an opposite direction, and the liner 166 begins to peel away from the adhesive layer 164, beginning at the coupling end of the liner 166, until the adhesive layer 164 of the screen protector assembly 160 is exposed. In some embodiments, in the second configuration, one of the first tray portion 120 or the second tray portion 130 is a moving tray, and the other is a stationary tray. The moving tray is moveable along a length of the stationary tray. The slot 150 extends through a wall of the moving tray. Pulling the pull tab 180 through the opening draws the moving tray towards the stationary tray along the longitudinal axis of the tray assembly 110 against the handheld device 10 until the handheld device 10 is aligned within the hollow region. Once the handheld device 10 is aligned, pulling the pull tab 180 begins to peel the liner 166 starting at the coupling end of the liner 166 until the adhesive layer 164 is exposed.

Referring generally to FIGS. 2-8, a screen protector installation system 200 is shown, according to some embodiments. The screen protector installation system 200 is functionally and/or structurally similar to the screen protector installation system 100 of FIG. 1. The screen protector installation system 200 includes a tray assembly 210, a screen protector assembly 260, and an outer container 290. The screen protector installation system 200 is configured to receive the handheld device 10 and align the handheld device 10 and the screen protector assembly 260 prior to installation. In operation, the handheld device 10 is placed within the screen protector installation system 200 with a device screen 16 facing the screen protector assembly 260.

The tray assembly 210 is functionally and/or structurally similar to the tray assembly 110 of FIG. 1. The tray assembly 210 is disposed within the outer container 290. The tray assembly 210 includes a first tray portion 220, a second tray portion 230, a tray keying feature 240, and a slot 250. The tray assembly 210 defines a longitudinal axis 211 and has a first peripheral edge 214 at a first end 212, a second peripheral edge 218 at a second end 216 opposite the first end 212, and lateral edges 215. The tray assembly 210 is configured to receive and align the screen protector assembly 260 and the handheld device 10. The screen protector assembly 260 is aligned relative to the tray assembly 210. The handheld device 10 is also aligned relative to the tray assembly 210. Thus, the tray assembly 210 acts as a datum (e.g., a reference point) for aligning the screen protector assembly 260 and the handheld device 10. Employing the tray assembly 210 as a datum provides more precisely controlled and consistent positioning/ alignment of the screen protector assembly 260 and the handheld device 10.

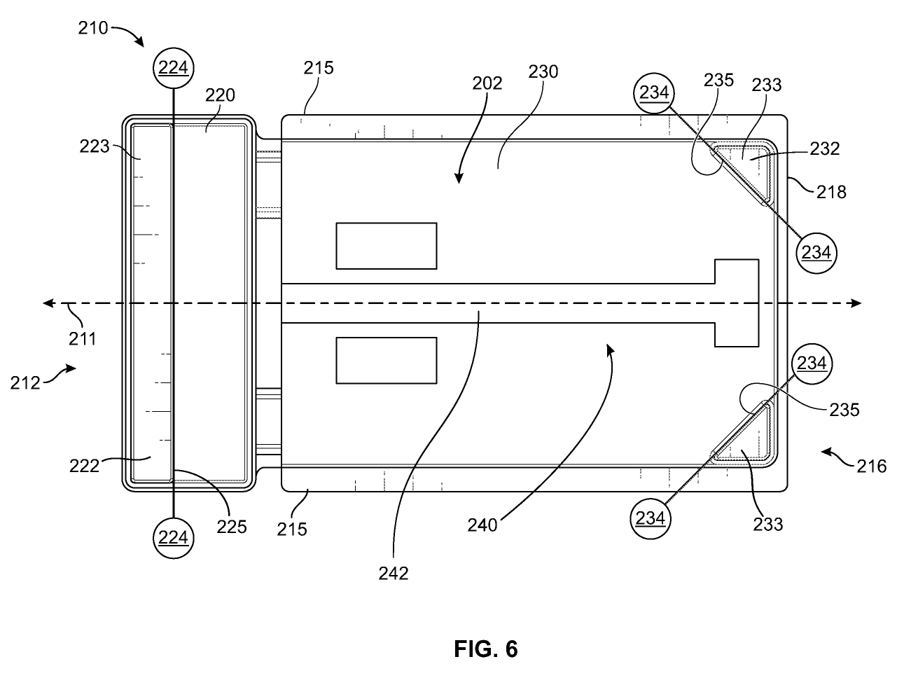

The first tray portion 220 is disposed at the first end 212 of the tray assembly 210. The first tray portion 220 is functionally and/or structurally similar to the first tray portion 120 of FIG. 1. The first tray portion 220 includes a first projection 222 extending from the first peripheral edge 214. The first projection 222 includes a surface defining a first locating plane 224 configured to abut an edge 12 of the handheld device 10. The first locating plane 224 is configured to abut the edge 12 of the handheld device 10. The edge 12 is aligned with the first locating plane 224. The first locating plane 224 therefore provides a linear constraint along an axis in the direction of the edge 12 and provides a guiding reference for positioning the handheld device 10. The linear constraint ensures that the handheld device is positioned in one direction relative to the first locating plane 224. In some embodiments, as shown in FIG. 6, the first projection 222 can be a block 223 having a perpendicular surface 225 to the longitudinal axis 211 extending along at least a portion of the first peripheral edge 214. In some embodiments, the first projection 222 extends across the entirety of the first peripheral edge 214 or extends across a portion of the first peripheral edge 214 centered along the first peripheral edge 214. The perpendicular surface 225 defines the first locating plane 224. In some embodiments, the first locating plane 224 includes one or more first locating planes that are coplanar and spaced apart. The one or more first locating planes align portions of the edge 12 of the handheld device.

The second tray portion 230 is disposed at the second end 216 of the tray assembly 210. The second tray portion 230 is functionally and/or structurally similar to the second tray portion 130 of FIG. 1. The second tray portion 230 includes a second projection 232 extending from the second peripheral edge 218 and defines at least one second locating plane 234 configured to abut an end 13, or a corner or rounded corner disposed proximate the end 13, of the handheld device 10 opposite the edge 12 abutting the first locating plane 224. The at least one second locating plane 234 contacts a point on a border 18 (e.g. such as a point on the corner or rounded corner of the outer peripheral edge or sidewall) of the handheld device 10, providing a point-based constraint restricting movement along an axis perpendicular to the first locating plane 224. In some embodiments, as shown in FIG. 6, the second projection 232 can be a pair of angled blocks 233 mirrored across the longitudinal axis 211 defining a pair of second locating planes 234. The pair of angled blocks 233 can be triangular blocks disposed at the corners of the second tray portion 230 on opposite ends of the second peripheral edge 218. Each angled block of the pair of angled blocks 233 has a surface extending between the second peripheral edge 218 and one of the lateral edges 215 defining a second locating plane 234. Each second locating plane 234 is angled and is tangent to the border 18 (or edge, or sidewall) of the handheld device 10, contacting a point on the end 13 of the handheld device 10. Therefore, movement is restricted in a direction perpendicular to the first locating plane 224 and in a direction parallel to the first locating plane 224. The pair of second locating planes 234 further prevent rotation of the handheld device 10 and provide stability. Advantageously, the angled surfaces of the pair of the second locating planes 234 can be used to receive and align a range of lengths and widths within the hollow region, allowing the tray assembly 210 to be compatible with multiple handheld devices.

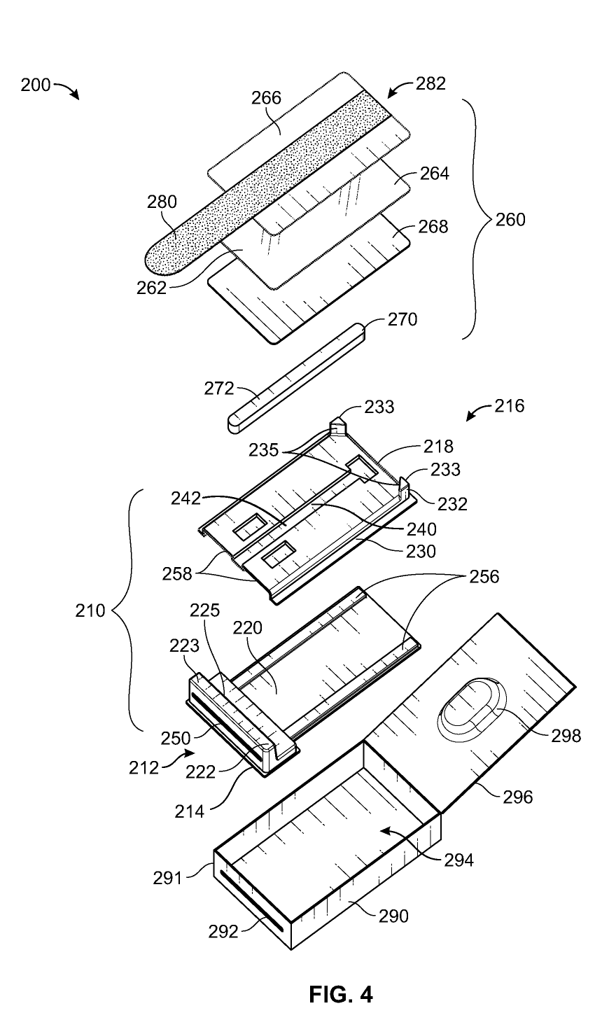

Referring to FIGS. 4-6, in one embodiment, the first tray portion 220 and the second tray portion 230 are configured to telescope along the longitudinal axis 211. One tray portion is inserted inside the other tray portion (e.g., nested), or is overlapped by the other tray portion, allowing for adjustable length of the tray assembly 210. In some embodiments, one of the first tray portion 220 and the second tray portion 230 is slidingly moveable along a length of the other. For example, in one embodiment as shown in FIG. 4, the first tray portion 220 is a bottom tray portion, and the second tray portion 230 is a top tray portion having a section thereof that is disposed on top of and overlaps a section of the bottom tray portion. In this embodiment, the bottom tray portion is slidably movable along the longitudinal axis 211 with respect to the top tray portion. For example, the bottom tray portion may slidingly move along a length of the top tray portion. In some embodiments, the top tray portion may be slidably moveable along the longitudinal axis 211 with respect to the bottom tray portion. For example, the top tray portion may slidingly move along a length of the bottom tray portion. The first tray portion 220 includes at least one ridge 256 extending parallel to the longitudinal axis 211. The second tray portion 230 includes a channel, or groove 258 configured to receive the at least one ridge 256 and move along a length of the at least one ridge 256. While FIGS. 4-6 depict a portion of first tray portion 220 being received by the second tray portion 230, in some embodiments, the first tray portion 220 can receive a portion of the second tray portion 230. For example, the at least one ridge 256 may be provided on the second tray portion 230, and the groove 258 may be provided on the second tray portion 130.

The first locating plane 224 of the first tray portion 220 and the at least one second locating plane 234 of the second tray portion 230 define a hollow region 202 within the tray assembly 210 to align the handheld device 10. The first locating plane 224 and the at least one second locating plane 234 automatically align the handheld device 10 when it is placed into the hollow region 202, providing multiple points of contact with the handheld device 10. Thus, movement of the handheld device 10 is restricted in multiple directions, aiding in proper alignment of the handheld device 10 within the tray assembly 210. Moving one of the first tray portion 220 and the second tray portion 230 along a length of the other can therefore adjust a size of the hollow region 202 to receive and align a handheld device 10 having different dimensions.

In some embodiments, there are set positions along a length of the other of the first tray portion 220 or the second tray portion 230, each set position associated with a range of handheld device dimensions that may be received in the hollow region 202. For example, one set position may be associated with handheld devices with a specific range of lengths. The set positions may be indicated by notches, marks, stops, holes, locks, sliders, and the like. Or, each set position may be set by use of a jig, insert, or spacer, and the like.

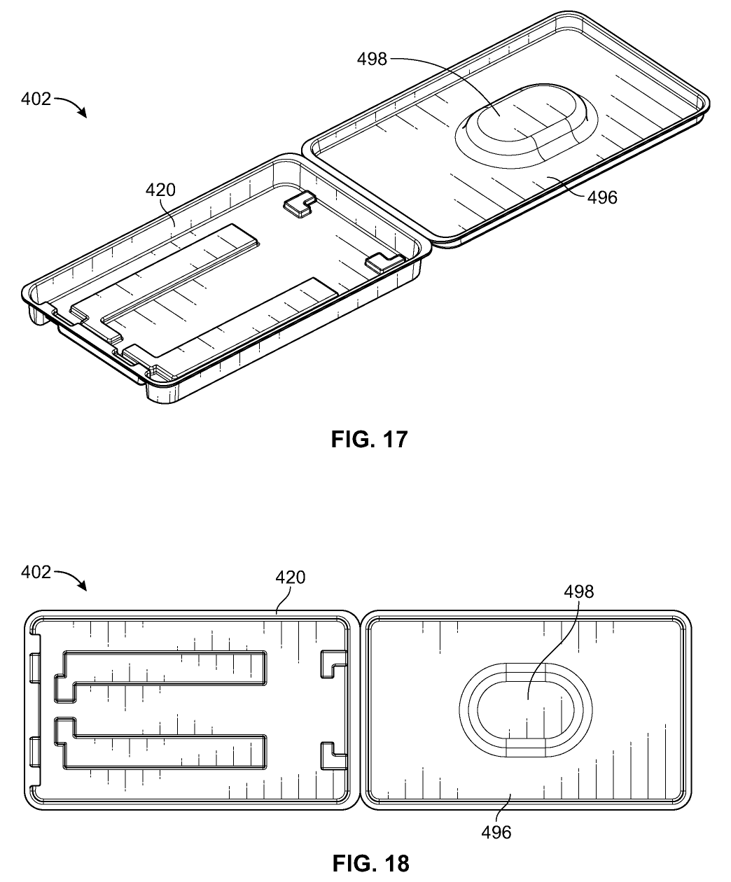

In some embodiments, the first tray portion 220 and the second tray portion 230 may be received within multiple different outer containers. For example, the first tray portion 220 and the second tray portion 230 can be slidingly moved to a range of positions at various lengths apart from one another. The positions may be associated with different handheld devices, or different dimensions of handheld devices. The first tray portion 220 and the second tray portion 230 can be affixed in each position by affixing the first tray portion 220 and the second tray portion 230 to one another, or by affixing at least one of the first tray portion 220 and the second tray portion 230 to an outer container corresponding to the position. In some embodiments, at least one of the first tray portion 220 or the second tray portion 230, and/or any of the respective features thereof, are integrally formed (e.g., molded) with or into an outer container (i.e. the various features of one or more of the inner tray or outer tray, including block 223 or angled blocks 233, are molded into the outer container). In such an embodiment, the other tray may be affixed or secured in place with respect to the molded-in tray portion. Therefore, the tray assembly 110 is universal (e.g., compatible, adaptable) for use across a wide range of handheld devices. The tray assembly 110 can be shared across different handheld devices, and is therefore more cost-effective, consistent, and sustainable than existing solutions. In some embodiments, for example, as shown in FIGS. 17-18, only one tray portion is universal. For example, one tray portion may be a shared tray portion adaptable for use across a range of handheld devices, and the other (not shown in FIGS. 17-18) may be a specific tray portion that is formed to be particular to a specific handheld device (e.g., a particular model or size, etc.). The specific tray may include a number of features that locks the specific tray portion to the shared tray portion at a position that corresponds to the specific handheld device, and prevents any sliding movement between the two tray portions.

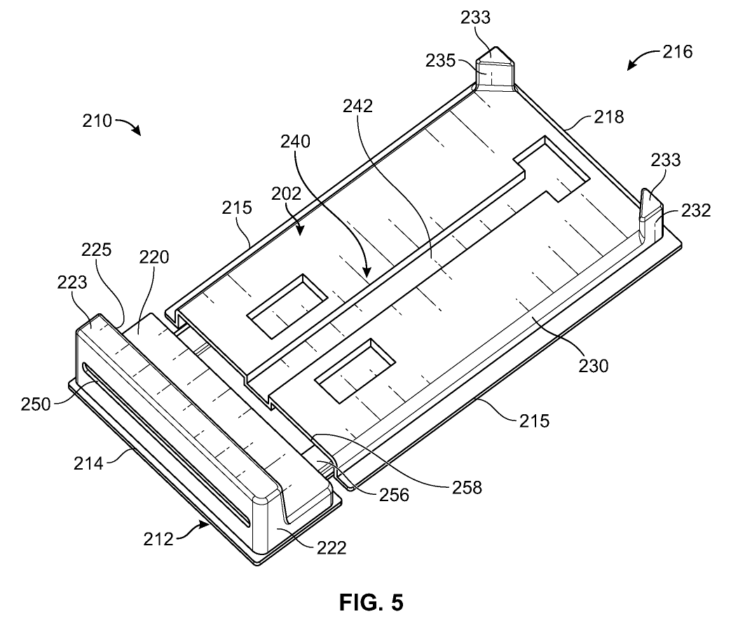

Referring further to FIG. 5-6, the tray keying feature 240 is configured to align the screen protector assembly 260 to the tray assembly 210. The tray keying feature 240 is functionally and/or structurally similar to the tray keying feature 140 of FIG. 1. The tray keying feature 240 is arranged such that the screen protector assembly 260 can be positioned in the tray assembly 110 and engage the tray keying feature 240 to align the screen protector assembly 260. In some embodiments, the tray keying feature 240 is a central channel 242 extending longitudinally through at least one of the first tray portion 220 or the second tray portion 230. For example, as shown in FIGS. 5-6, the central channel 242 extends longitudinally through the second tray portion 230. In some embodiments, the central channel 242 is machined, cut, or molded into the second tray portion 230.

The screen protector assembly 260 is received in the tray assembly 210. The screen protector assembly 260 is functionally and/or structurally similar to the screen protector assembly 160 of FIG. 1. The screen protector assembly 260 is configured to align with the tray assembly 210 and enable a user to couple (e.g., install, attach, adhere, etc.) a protective layer to device screen 16. The screen protector assembly 260 may have dimensions and features associated with the handheld device 10. For example, the screen protector assembly 260 may have dimensions substantially the same as the device screen 16, or the screen protector assembly 260 may have dimensions such that it covers a portion of the screen of the handheld device 10. The screen protector assembly 260 includes a screen protector 262, an adhesive layer 264, a liner 266, a cap sheet 268, and a screen protector keying feature 270. In some embodiments, additional screen protector assemblies 260 can be provided for multiple installations using the screen protector installation system 200.

The screen protector 262 is the primary protective layer configured to adhere to and protect the device screen 16. The screen protector 262 is functionally and/or structurally similar to the screen protector of FIG. 1. The screen protector 262 is configured to couple (e.g., attach, affix, adhere, stick, etc.) to a surface of the handheld device 10 via the adhesive layer 264. The adhesive layer 264 is functionally and/or structurally similar to the adhesive layer 164 of FIG. 1. The liner (e.g., a release liner, a backing layer, a protective backing etc.) 266 is removably coupled to the adhesive layer 264 to cover and protect the adhesive layer 264. The liner 266 is functionally and/or structurally similar to the liner 166 of FIG. 1. The liner 266 is configured to be removed prior to installation of the screen protector 262 onto the device screen 16. The cap sheet (e.g., a protective film, a top layer film, etc.) 268 is removably coupled to the screen protector 262 on a side opposite the liner 266 to protect an exposed surface of the screen protector 262. The cap sheet 268 is functionally and/or structurally similar to the cap sheet 168 of FIG. 1. The cap sheet 268 is configured to be removed after installation of the screen protector 262 onto the handheld device 10.

The screen protector keying feature 270 is coupled (e.g., using adhesive, welding, fastened, snap fit, press fit, etc.) to the cap sheet 268 and is complementary to the tray keying feature 240. In some embodiments, the screen protector keying feature 270 is integrally formed with the cap sheet 268. The screen protector keying feature 270 is configured to engage the tray keying feature 240 and align the screen protector assembly 260 to the tray assembly 210. The screen protector keying feature 270 further presses the screen protector against the device screen 16 during installation to facilitate removal of air bubbles during installation. In some embodiments, the screen protector keying feature 270 can be used to facilitate removal of the cap sheet 268 from the screen protector 262. For example, the screen protector keying feature 270 can provide a grasping surface for a user to more easily peel the cap sheet 268 off the screen protector 262.

In some embodiments, the tray keying feature 240 and the screen protector keying feature 270 may include at least one of a slot and tab, interlocking features, raised surfaces and grooves, pins and holes, and the like. For example, as shown in FIG. 8, the screen protector keying feature is a rib 272 coupled to the cap sheet 268 configured to be received within the central channel 242. The rib 272 is aligned with a longitudinal axis of screen protector assembly 260 (i.e. a central longitudinal axis of the rib is laterally aligned with a central longitudinal axis of the screen protector assembly, so that the rib is laterally centered on the screen protector assembly). The central channel 242 provides a linear guide to align the rib 272 accurately along a specific direction or plane and restricts lateral or angular movement of the rib 272 with respect to the tray assembly 210, ensuring proper positioning and alignment of the screen protector assembly 260 to or with the tray assembly 210.

The rib 272 further presses against the screen protector 262 and the device screen 16 during installation, thereby creating contact points along the central longitudinal axis of the screen protector assembly to dissipate (e.g., evacuate, push out, remove) air bubbles caught between the adhesive layer 264 and the device screen 16. The rib 272 allows the screen protector 262 to be applied with more evenly distributed pressure, thereby reducing air bubbles. In some embodiments, the rib 272 is affixed or secured (e.g., glued, pressed, etc.) within the central channel 242, further restricting movement. For example, at least a portion of the rib 272 may be glued into the central channel 242. In such embodiments, securing the rib 272 to the central channel 242 also secures the cap sheet 268 within the tray assembly 210. As the cap sheet 268 is fixed, it can be easily removed from the screen protector 262 by simply lifting the handheld device 10.

The pull tab 280 is coupled to the liner 266 at a coupling end 282 of the liner 266. The pull tab 280 is configured to extend longitudinally over (e.g., fold back over) the entire length of the liner 266 and extend through the slot 250 of the tray assembly 210. The pull tab 280 is functionally and/or structurally similar to the pull tab 180 of FIG. 1. The screen protector assembly 260 is arranged within the tray assembly 210 such that the coupling end 282 of the liner is opposite the slot 250. The pull tab 280 is configured to be pulled through the slot 250 away from the coupling end 282 thereby pulling an edge of the liner 266 at the coupling end 282 180-degrees back onto itself to initiate the liner peeling away from the adhesive layer 264. Continued pulling of the pull tab 280 peels (e.g., removes, delaminates, etc.) the liner 266 fully off the adhesive layer 264, and out through both of the slot 250 and the opening 292 of the outer container 290, to install the screen protector 262 on the device screen 16. During installation, the pull tab 280 travels through a fixed path defined by the slot 250, therefore the pull tab 280 is aligned as it is pulled. The pull tab 280 is configured to be accessible and easy to grip such that a user may easily grasp and pull the pull tab 280. The pull tab 280 and the liner 266 may then be disposed. The pull tab 180 can be a variety of materials selected for durability, flexibility, or ease of use. For example, the pull tab can be plastic (e.g., polypropylene (PP), polyethylene (PE), polylactic acid (PLA), etc.), fabric, silicone, paper, etc.)

The slot 250 is configured to direct the pull tab 280 along a predetermined path. The slot 250 may have a shape and dimensions selected to prevent lateral or unintended movement of the pull tab 280. The slot 250 may be formed with a consistent width and depth that corresponds to the dimensions of the pull tab 280, ensuring the pull tab 280 fits snugly within the slot 250 while still allowing smooth, uninterrupted movement along its length. This slot 250 aligns the pull tab 280 along a straight line, minimizing the risk of skewing or misdirection, and ensures consistent, efficient operation of the pull tab 280 (e.g., pulling the pull tab 280). Further, as the pull tab 280 is pulled through the slot 250, the tension applied to the liner 266 is evenly distributed ensuring the liner 266 is pulled smoothly from the adhesive layer 264, preventing the liner 266 from getting stuck, snagging, tearing, bunching, and/or folding over itself. The arrangement of the slot 250 and the pull tab 280 provide a controlled and precise removal of the liner 266, reducing the likelihood of user frustration.

Referring to FIG. 4, the tray assembly 210 and the screen protector assembly 260 are disposed within an outer container 290. The outer container 290 includes sidewalls 291 defining an opening 292 and a cavity 294. The cavity 294 is configured to receive the tray assembly 210, the screen protector assembly 260, and the handheld device 10. In some embodiments, the outer container 290 is made of cardboard, fiberboard, paper pulp, and the like. A lid 296 is removably coupled to the outer container 290 and encloses the outer container 290 in a closed position. The lid 296 may be hingedly attached to the outer container 290 or separate from the outer container 290. In use, a user places the handheld device 10 into the tray assembly 210 within the outer container 290, and closes the lid 296 prior to installation. A retaining member 298 coupled to an inner surface of the lid 296 configured to extend into the cavity and secure the handheld device 10 in the closed position. The retaining member 298 presses against a back surface of the handheld device 10, opposite the device screen 16, to hold the handheld device 10 in an aligned position for installation. The retaining member 298 can be a protrusion, a spring, a gasket, tabs, flanges, and the like. In some embodiments, the opening 292 is aligned with the slot 250 such that the pull tab 280 further extends through the slot 250. In some embodiments, the tray assembly is disposed within the outer container so that the slot 250 is positioned at the same end as, and adjacent to, the opening 292 in the outer container 290. However, in alternate embodiments as will be discussed below, the tray assembly 210 is disposed within the outer container 290 so that the slot 250 is disposed at an end of the outer container 290 opposite the opening 292 in the outer container 290.

In some embodiments, to operate the screen protector installation system 200, the user opens the outer container 290, which contains the tray assembly 210 and the screen protector assembly 260. The user places the handheld device 10 into the tray assembly 210 (e.g. face down) with the device screen 16 facing the screen protector assembly 260. The handheld device 10 is automatically aligned within the tray assembly 210 via the first locating plane 224 and the at least one second locating plane 234, as described above, ensuring the handheld device is positioned correctly and securely within the hollow region 202. The user then closes the lid 296 to close the outer container 290 and press the retaining member 298 against the handheld device 10 (e.g. against a back surface of the handheld device 10) to secure the handheld device 10.

Once the handheld device 10 is positioned within the tray assembly 210, the user is ready to proceed with installing the screen protector 262. The screen protector assembly 260 is pre-positioned within the tray assembly 210, with the liner 266 covered adhesive layer 264 of the screen protector 262 facing the device screen 16 (e.g. the screen protector assembly 260 is positioned in the tray assembly 210 with the adhesive layer 264 facing upwards, and with the liner 266 and the pull tab 280 disposed on top of the adhesive layer 264). The user can easily grasp the pull tab 280 extending through the slot 250 in the tray assembly 210 and the opening 292 of the outer container 290. The user grasps the pull tab 280 and pulls it through the slot 250, as the slot 250 guides the pull tab along a straight line. This controlled path ensures that the liner 266 is removed smoothly without any risk of snags, tears, or misalignment. As the user pulls the pull tab 280, the tension applied to the edge of the liner 266 connected to the pull tab 280 is evenly distributed, allowing the liner to separate or peel back from the adhesive layer 264 of the screen protector 262. The user continues pulling the pull tab 280 until the entire liner 266 is removed, thereby fully exposing the adhesive layer 264 of the screen protector 262 to the device screen 16 that is now disposed immediately adjacent thereto. This in turn, together with any pressure applied to the back surface of the handheld device 10, causes the screen protector 262 to immediately and automatically contact the device screen 16 and adhere the screen protector 262 to the device screen 16. The precise alignment provided by the tray assembly 210 ensures that the screen protector 262 is aligned with the device screen 16 during the entire installation process.

Once the liner 266 has been fully removed, the adhesive layer 264 automatically contacts the device screen 16 of the handheld device 10. After installation, the user can remove or open the lid 296 and remove the handheld device 10 from the outer container 290. Then, the user can remove the cap sheet 268 from the screen protector 262. In some embodiments, the screen protector keying feature 270 is affixed to the tray keying feature 240, thereby affixing the cap sheet 268 to the tray assembly 210. Therefore, as the user removes the handheld device 10, the user simultaneously removes the cap sheet 268 from the screen protector 262, leaving the cap sheet 268 within the outer container 290. If desired, the user can additionally press the screen protector 262 down evenly to ensure that it adheres firmly and securely to the device screen 16, and that there are no air bubbles.

In some embodiments, the screen protector installation system 200 may be configured as a machine for use in a retail location, such as a mobile device store or electronics retailer, where the retailer uses the screen protector installation system 200 to install a screen protector for a customer. The screen protector installation system 200 allows retailers to easily accommodate various models of handheld devices, importantly, as handheld devices are rapidly developed, by adjusting the machine to fit different handheld devices of various sizes. In particular, the first tray portion 220 and the second tray portion 230 of the tray assembly 210 are adjustable to accommodate different device sizes. The tray assembly 210 may include a motorized or manual adjustment mechanism that allows the retailer to control and/or modify the size of the hollow region 202 to receive and align different handheld devices of various sizes and/or shapes. In some embodiments, the screen protector installation system 200 may be automated, in which the retailer places the handheld device 10 into the tray assembly 210, and the machine automatically positions the handheld device 10 and applies the screen protector 262. In some embodiments, the screen protector installation system 200 may be semi-automated, in which the retailer manually aligns the handheld device 10 and activates an automatic pull tab mechanism to remove the liner 266 and apply the screen protector 262 to the device screen 16.

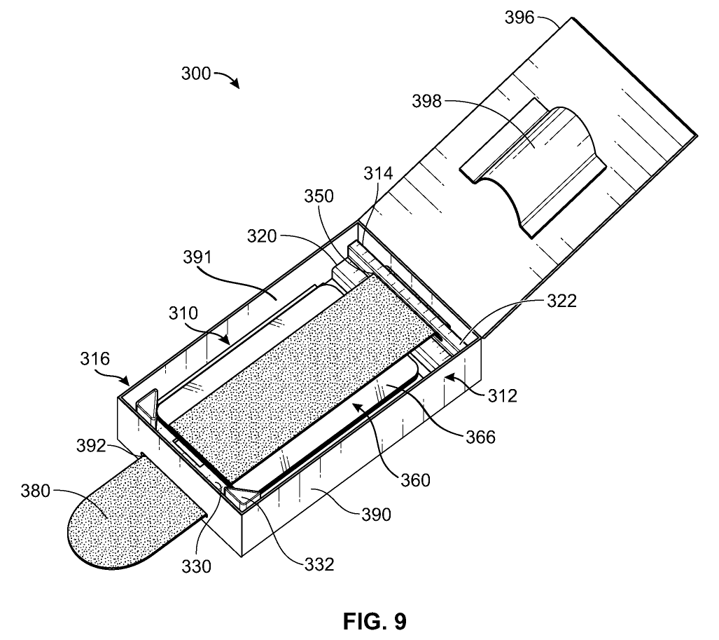

Referring generally to FIGS. 9-16, a screen protector installation system 300 is shown, according to some embodiments. The screen protector installation system 300 is functionally and/or structurally similar to the screen protector installation system 200 of FIGS. 2-8 and the screen protector installation system 100 of FIG. 1. The screen protector installation system 300 includes a tray assembly 310, a screen protector assembly 360, and an outer container 390. The screen protector installation system 300 is configured to receive a handheld device 10 and align both the handheld device 10 and the screen protector assembly 360 prior to installation (e.g., positioning the handheld device 10 in an aligned position 20). In use, the handheld device 10 is placed within the tray assembly 310 with a device screen 16 of the handheld device 10 facing the screen protector assembly 360. There may be clearance between the handheld device 10 and the tray assembly 310.

Referring to FIG. 9, the outer container 390 includes sidewalls 391 that define an opening 392 and a cavity 394. The outer container 390 is functionally and/or structurally similar to the outer container 290 of FIGS. 2-8 and the outer container 190 of FIG. 1. In some embodiments, the outer container 390 may be substantially rectangular. The cavity 394 is configured to receive the tray assembly 310, the screen protector assembly 360, and the handheld device 10. In some embodiments, a lid 396 may be one of hingedly attached or removably attached to the outer container 390, enclosing it in a closed position. A retaining member 398, coupled to an inner surface of the lid 396, extends into the cavity 394 and presses against a back surface of the handheld device 10 to hold it securely in place for installation of the screen protector 262on the device screen. The retaining member 398 can be a protrusion, a spring, a gasket, tabs, flanges, and the like.

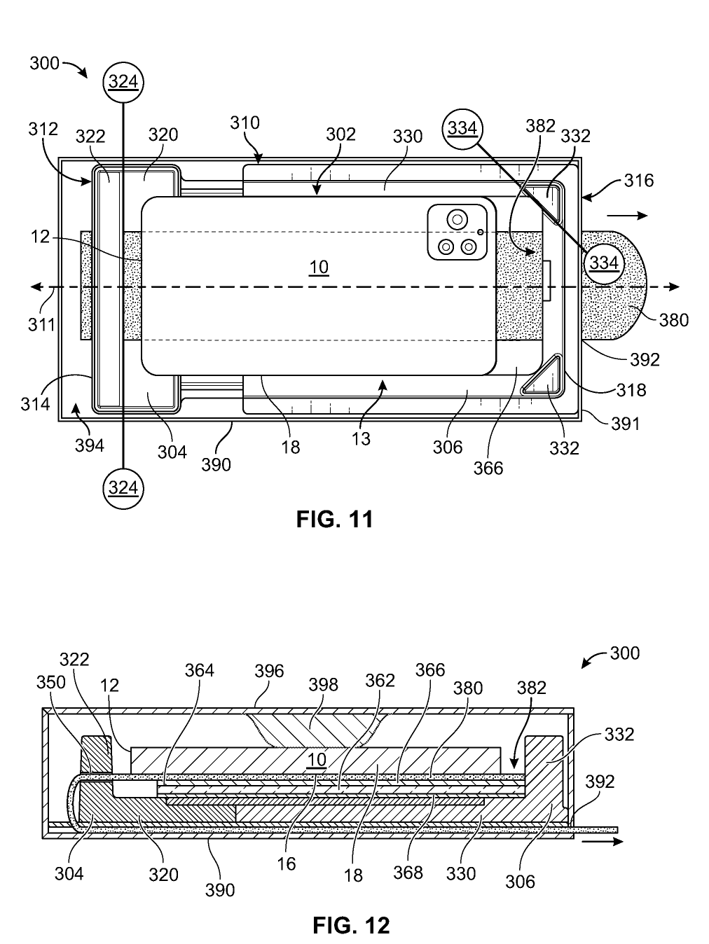

Referring to FIGS. 11-16, the tray assembly 310 is disposed within the outer container 390. The tray assembly 310 is functionally and/or structurally similar to the tray assembly 210 of FIGS. 2-8 and the tray assembly 110 of FIG. 1. At least a portion of the tray assembly 310 may be affixed to the outer container 390. The tray assembly 310 defines a longitudinal axis 311 and has a first peripheral edge 314 at a first end 312, a second peripheral edge 318 at a second end 316 opposite the first end 312, and lateral edges 315. The tray assembly 310 includes a first tray portion 320, a second tray portion 330, and a slot 350. The tray assembly 310 may include a tray keying feature (not shown). The tray assembly 310 of the present embodiment is dynamically adjustable and configured to continuously adjust to receive and align handheld devices having a range of sizes and shapes. The screen protector assembly 360 is aligned relative to the tray assembly 310, and the handheld device 10 is also aligned relative to the tray assembly 310. The tray assembly 310 acts as a datum (e.g., a reference point) for aligning both the screen protector assembly 360 and the handheld device 10, ensuring precise positioning for proper installation.

The first tray portion 320 is disposed at the first end 312 of the tray assembly 310. The first tray portion 320 is functionally and/or structurally similar to the first tray portion 220 of FIGS. 2-8 and the first tray portion 120 of FIG. 1. The first tray portion 320 includes a first projection 322 extending from the first peripheral edge 314. The first projection 322 defines a first locating plane 324. When the handheld device 10 is in the aligned position 20 within the tray assembly 310, the first locating plane 324 abuts an edge 12 of the handheld device 10, aligning the handheld device 10 along one axis. The first locating plane 324 provides a linear constraint in one direction relative to the edge 12 of the handheld device 10, acting as a guiding reference during installation. In some embodiments, as shown in FIGS. 2-8 above, the first projection 322 can be a block with a perpendicular surface relative to the longitudinal axis 311. The perpendicular surface defines the first locating plane 324.

The second tray portion 330 is disposed at the second end 316 of the tray assembly 310. The second tray portion 330 is functionally and/or structurally similar to the second tray portion 230 of FIGS. 2-8 and the second tray portion 130 of FIG. 1. The second tray portion 330 includes a second projection 332 extending from the second peripheral edge 318 and defines at least one second locating plane 334. When the handheld device 10 is in the aligned position 20 within the tray assembly 310, the at least one second locating plane 334 abuts an end 13 or corner of the handheld device 10 disposed opposite the edge 12 located against the first locating plane 324, thereby providing a point-based constraint that restricts movement along an axis perpendicular to the first locating plane 324. This arrangement prevents rotation of the handheld device 10 within the tray assembly 310 and ensures stability of installation. In some embodiments, as shown in FIGS. 2-8 above, the second projection 332 can include or be a pair of angled blocks positioned symmetrically on opposite sides of the longitudinal axis 311. These angled blocks define a pair of second locating planes 334 that serve to further restrict lateral and angular movement of the handheld device 10.

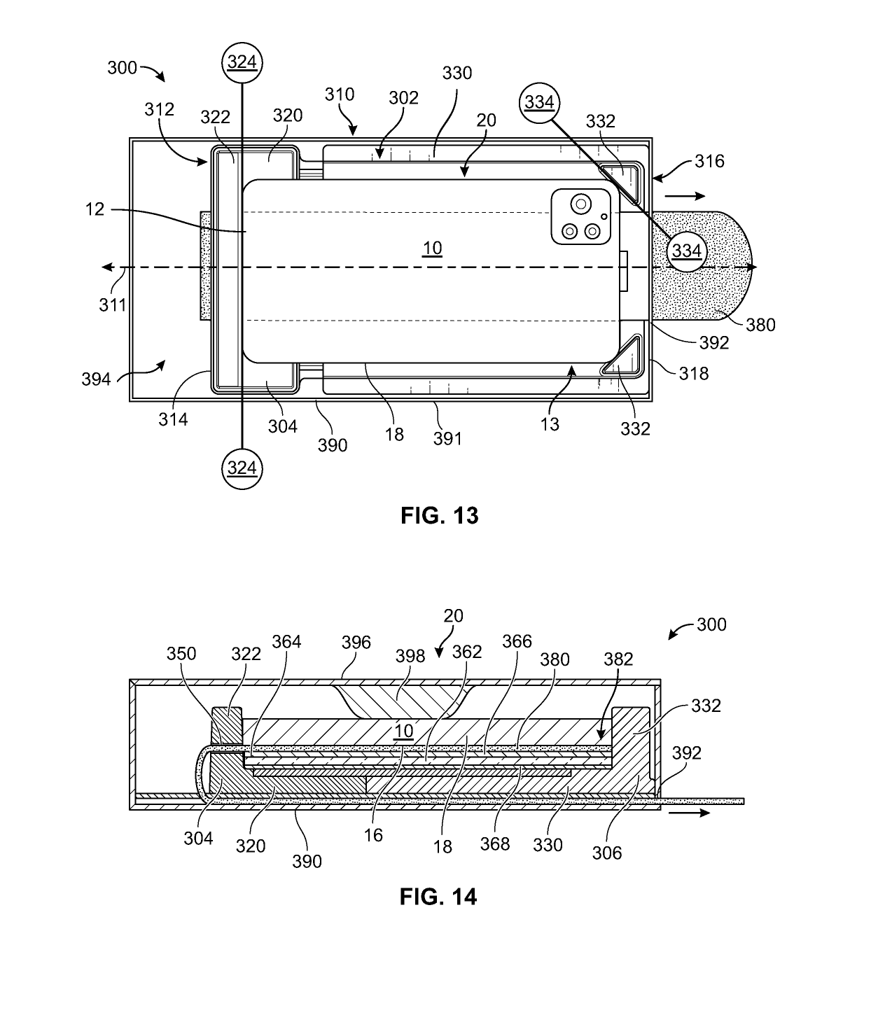

The first locating plane 324 and the at least one second locating plane 334 define a hollow region 302 within the tray assembly 310 configured to receive the handheld device 10. As shown in FIGS. 13-14, when the first locating plane 324 abuts the edge 12 of the handheld device 10 and the at least one second locating plane 334 abuts an end 13 of the handheld device opposite the edge 12, the handheld device is in the aligned position 20. The positioning of the handheld device 10 in the aligned position 20 is facilitated by the first locating plane 324 and the at least one second locating plane 334 contacting the handheld device 10, ensuring that movement is restricted in multiple directions.

One of the first tray portion 320 or the second tray portion 330 is a moving tray 304, and the other is a stationary tray 306. For example, the moving tray 304 may be the first tray portion 320 or the second tray portion 330. The moving tray 304 is slidingly moveable relative to the stationary tray along the longitudinal axis 311 and along a length of the stationary tray 306. The stationary tray 306 may be adhered to, or integrally formed with the outer container 390. The moving tray 304 is configured to move along the length of the stationary tray 306 to adjust a size of the hollow region 302 to accommodate handheld devices having differences in size and/or shape. For example, in some embodiments, the second tray portion 330 can be the stationary tray 306, configured as an upper or top tray portion affixed to at least a portion of the floor of the outer container 390 and having a gap/clearance defined between the floor of the outer container 390 and a telescoping section of the top tray portion 330 (e.g., a groove, a channel, a recess, a pocket, a slot, a cavity, an indentation, a notch, a trench, a ridge, etc.). The first tray portion 320 can be the moving tray 304, configured as a lower tray portion having a telescoping section that is overlapped by the upper telescoping section of the stationary tray 306. The telescoping section of the first tray portion 320 is slidably mated within the gap/clearance defined by the telescoping section of the second tray portion 330.

In use, the handheld device 10 is positioned within the tray assembly 310 between the moving tray 304 and the stationary tray 306. As shown in FIGS. 11-12, there may be clearance between the handheld device 10 and the tray assembly 310. The handheld device 10 is not yet aligned. The moving tray 304 is configured to move along the length of the stationary tray 306 in order to clamp (e.g., press, grip, squeeze, holds, etc.) down on opposing ends of the handheld device 10, thereby sandwiching the handheld device 10 between the moving tray 304 and the stationary tray 306. As shown in FIGS. 13-14, the tray assembly 310 therefore orients the handheld device 10 into the aligned position 20 for applying the screen protector thereto.

The slot 350 in the tray assembly 310 extends through a wall of the moving tray 304 and is configured to be positioned opposite the opening 392 defined in the outer container 390. The slot 350 is functionally and/or structurally similar to the slot 250 of FIGS. 2-8 and the slot 150 of FIG. 1. The slot 350 may have a shape and dimensions selected to prevent lateral or unintended movement of the pull tab 380. The slot 350 may be formed with a consistent width and depth that corresponds to the dimensions of the pull tab 380, ensuring the pull tab 380 fits snugly within the slot 350 while still allowing smooth, uninterrupted movement along its length. In some embodiments, the opening 392 is substantially the same shape and size as the slot 350. For example, the opening may be slot shaped. The slot 350 is designed to guide a user's motion during installation.

The tray keying feature is configured to align the screen protector assembly 360 to the tray assembly 310. The tray keying feature is functionally and/or structurally similar to the tray keying feature 240 of FIGS. 2-8 and the tray keying feature 140 of FIG. 1. The tray keying feature is configured to engage a complementary feature of the screen protector assembly 360 to laterally align the screen protector assembly 360 to the tray assembly 310.

The screen protector assembly 360 is received within the tray assembly 310. The screen protector assembly 360 is functionally and/or structurally similar to the screen protector assembly 260 of FIGS. 2-8 and the screen protector assembly 160 of FIG. 1. The screen protector assembly 260 is configured to align with the tray assembly 210 and enable a user to couple (e.g., install, attach, adhere, etc.) a protective layer to device screen 16. The screen protector assembly 360 includes a screen protector 362, an adhesive layer 364, a liner 366, and a cap sheet 368. The screen protector assembly 360 can also include screen protector keying feature (not shown). In use, the screen protector assembly 360 may be pre-positioned within the tray assembly 310 such that the adhesive layer 364 is positioned facing the device screen 16. The screen protector assembly 360 may have dimensions and features associated with the handheld device 10. For example, the screen protector assembly 360 may have dimensions substantially the same as the device screen 16, or the screen protector assembly 360 may have dimensions such that it covers a portion of the device screen 16.

The screen protector 362 is the primary protective layer configured to adhere to and protect the device screen 16. The screen protector 362 is functionally and/or structurally similar to the screen protector 262 of FIGS. 2-8 and the screen protector 162 of FIG. 1. The screen protector 362 is configured to couple (e.g., attach, affix, adhere, stick, etc.) to a surface of the handheld device 10 via the adhesive layer 364. The adhesive layer 364 is functionally and/or structurally similar to the adhesive layer 264 of FIGS. 2-8 and the adhesive layer 164 of FIG. 1. The liner (e.g., a release liner, a backing layer, a protective backing, etc.) 366 is removably coupled to the adhesive layer 364 to cover and protect the adhesive layer 364. The liner 366 is functionally and/or structurally similar to the liner 266 of FIGS. 2-8 and liner 166 of FIG. 1. The liner 366 is configured to be removed prior to installation of the screen protector 362 onto the device screen 16. The cap sheet (e.g., a protective film, a top layer film, etc.) 368 is removably coupled to the screen protector 362 on a side opposite the liner 366 to protect an exposed surface of the screen protector 362. The cap sheet 368 is functionally and/or structurally similar to the cap sheet 268 of FIGS. 2-8 and the cap sheet 168 of FIG. 1. The cap sheet 368 is configured to be removed after installation of the screen protector 362 onto the handheld device 10.

The screen protector keying feature is coupled (e.g., using adhesive, welding, fastened, snap fit, press fit, etc.) to the cap sheet 368 and is complementary to the tray keying feature. In some embodiments, the screen protector keying feature is integrally formed with the cap sheet 368. The screen protector keying feature is configured to engage the tray keying feature and align the screen protector assembly 360 to the tray assembly 310. In some embodiments, the screen protector keying feature can be used to facilitate removal of the cap sheet 368 from the screen protector 362. For example, the screen protector keying feature can provide a grasping surface for a user to more easily peel the cap sheet 368 off the screen protector 362. In another example, the screen protector keying feature is affixed to the tray keying feature, thereby fixing the cap sheet 368 within the tray assembly 310 and allowing a user to easily separate the screen protector 362 and the cap sheet 368. The screen protector keying feature can also be used to evenly apply pressure against the screen protector 362 during installation to reduce air bubbles. In some embodiments, the tray keying feature and the screen protector keying feature may include at least one of a slot and tab, slot or channel and a complementary rib, interlocking features, raised surfaces and grooves, pins and holes, and the like.

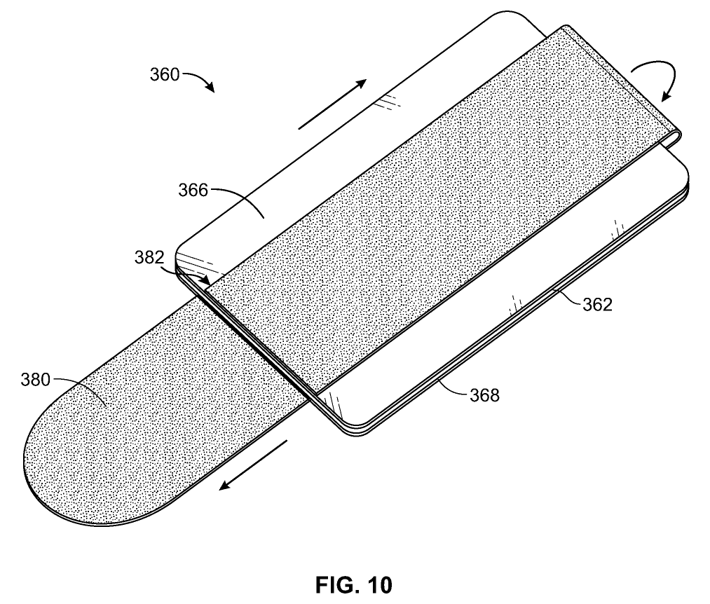

Referring to FIG. 10-16, the pull tab 380 is functionally and/or structurally similar to the pull tab 280 of FIGS. 2-8 and the pull tab 180 of FIG. 1. The pull tab 380 is coupled to the liner 366 at a coupling end 382 of the liner 366, extends longitudinally over the length of the liner 366 (e.g. the pull tab 380 either folds back on itself 180-degrees at the location of its connection to the liner 366, or otherwise the connection between the liner 366 and pull tab 380 is configured to direct the pull tab 380 at the coupling end 382 to extend longitudinally adjacent to and across the length of the liner 366), and extends through the slot 350 of the moving tray 304. After passing through the slot 350 of the moving tray 304, the pull tab 380 is wrapped 180-degrees downward and around the end of the moving tray and routed under the tray assembly 310 where it extends past the end of the stationary tray 306 and exits the outer container 390 by passing through the opening 392 defined in the outer container 390. The screen protector assembly 360 is arranged within the tray assembly 310 such that the coupling end 382 is positioned adjacent/proximate the opening 392 of the outer container 390. In some embodiments, the tray assembly 310 may include a groove (e.g., a recess, an indentation, etc.) on a lower surface of the tray assembly 310 that is configured to receive and guide the pull tab 380.

Pulling on the pull tab 380 from outside the outer container 390 and through the opening 392 initially applies a tension to the entire length of the pull tab 380 all the way back to the connection with the liner 366 at the coupling end 382 of the liner 366, and first, serves to remove any slack from the pull tab 380, without overcoming the adhesion strength between the liner 366 and adhesive layer 364 required to begin to peel the liner 366 from the adhesive layer 364 of the screen protector 362. Next, continued pulling on the pull tab 380 increases the tension in the pull tab 380 to a sufficient amount to cause the portion of the pull tab 380 that exits through the slot 350 of the moving tray 304, and is wrapped 180-degrees around and under the end of the moving tray 304, to drive or pull the moving tray 304 toward the stationary tray 306 along the longitudinal axis 311 of the tray assembly 310. Further, as shown in FIGS. 13-14, continuous pulling on the pull tab 380 continues to drive the moving tray 304, causing the first projection 322 of the moving tray 304 to contact the edge 12 of the handheld device 10 and align the edge 12 of the handheld device 10 with the first locating plane 324, and further drive the handheld device 10 toward the stationary tray 306 until the opposing end 13 or corner of the handheld device 10 abuts the at least one second projection 332 of the stationary tray 306, thereby simultaneously clamping the handheld device 10 between the first projection 322 and the at least one second projection 332, moving it to the aligned position 20 without peeling the liner from the adhesive layer of the screen protector.

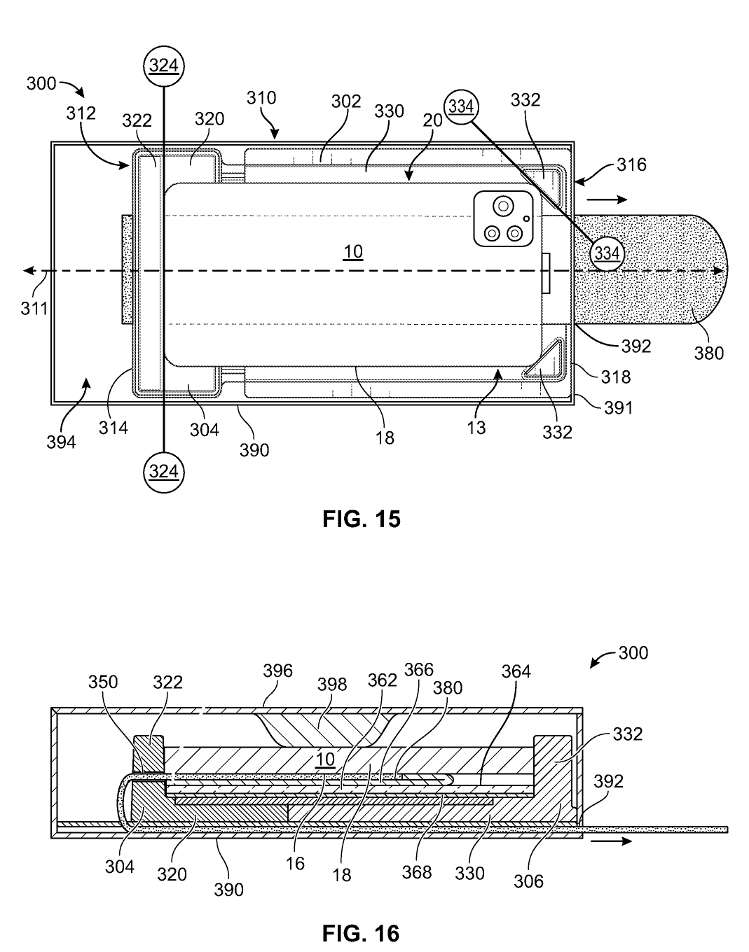

As shown in FIGS. 15-16, once the handheld device 10 is aligned and clamped in the tray assembly 310, further pulling on the pull tab 380 increases the tension in the pull tab 380 to the point at which the tension therein overcomes the adhesion strength between the liner 366 and the adhesive layer 364, and the pull tab 380 begins to peel back the liner 366 180-degrees on itself, starting at the coupling end 382 of the liner 366. Continuous pulling on the pull tab 380 peels back the liner 366 until the adhesive layer 364 is fully exposed and the liner 366 has been pulled completely through the slot 350 in the moving tray 304 of the tray assembly 310. Thus, the tray assembly 310 does not require discrete adjustments (e.g., fixed steps, predetermined positions, predetermined measurements, discrete stopping points, defined increments, etc.) to align and secure a given handheld device, as pulling the pull tab 380 allows continuous travel of the moving tray 304 along the length of the stationary tray 306. Continuous adjustment allows for more flexibility to accommodate a wider range of handheld devices. Additional force provided by the user pulling the pull tab 308 further aids in clamping down on the handheld device 10 to secure and align the handheld device 10.

In operation, a user opens the outer container 390, places the handheld device 10 into the tray assembly 310 between the moving tray 304 and the stationary tray 306, and closes the lid 396. The retaining member 398 holds the handheld device 10 in place. The user grasps the pull tab 380 extending out of the opening 392 of the outer container 390. The user pulls the pull tab 380 out of the opening 392 to align the handheld device 10 within the tray assembly 310, and to remove or peel back the liner 366 from the adhesive layer on the screen protector. The user continues to pull the pull tab 380 until the liner 366 is fully removed, and the adhesive layer 364 is exposed. Once the liner 366 is removed, the handheld device 10 either drops onto the adhesive layer 364, or is driven toward the adhesive layer 364 by pressure applied to the back surface of the handheld device 10, and the device screen 16 contacts the adhesive layer 364, thereby adhering the screen protector 362 to the device screen 16. After the screen protector 362 is applied, the user can remove the lid 396, remove the handheld device 10, and remove the cap sheet 368 from the screen protector 362, completing the installation process. In some embodiments, the screen protector keying feature is affixed to the tray keying feature, thereby affixing the cap sheet 368 to the tray assembly 310. Therefore, as the user removes the handheld device 10 with the applied screen protector 362, the user also removes the cap sheet 368 from the screen protector 362.

Referring generally to FIGS. 17-18, a lid portion 496 having a retaining member 498 and a bottom tray portion 420 are shown, according to an embodiment. The lid portion 496 is functionally and/or structurally similar to the lid 396 of FIGS. 9-16, the lid 296 of FIGS. 2-8, and the lid 196 of FIG. 1. The bottom tray portion 420 forms a stationary/fixed bottom tray of a tray assembly (e.g., tray assembly 110, tray assembly 210, tray assembly 310, etc.). While the bottom tray portion 420 shown in FIGS. 17-18 is functionally and/or structurally similar to the first tray portion 320 of FIGS. 9-16, the first tray portion 220 of FIGS. 2-8, and the first tray portion 120 of FIG. 1, in some embodiments, the bottom tray portion 420 may be functionally and/or structurally similar to the second tray portion 330 of FIGS. 9-16, the second tray portion 230 of FIGS. 2-8, and the second tray portion 130 of FIG. 1. The lid portion 496 and the bottom tray portion 420 are hingedly attached to one another, each forming a half of a clamshell 402.

As shown in FIG. 17, in a fully extended open position, an upper surface of the lid portion 496 and an upper surface of the bottom tray portion 420 are substantially parallel and face upwards. In a closed (e.g., enclosed) position, the lid portion 496 and the bottom tray portion 420 are folded towards each other, and the upper surface of the lid portion 496 and the upper surface of the bottom tray portion 420 are substantially parallel and face one another. In some embodiments, the lid portion 496 and the bottom tray portion 420 each include a peripheral wall forming a flat mating face. The flat mating face of the lid portion 496 and the flat mating face of the bottom tray portion 420 at least partially contact each other when the clamshell 402 is in a closed position. The lid portion 496 and the bottom tray portion 420 may be integrally formed and folded over, or they can be coupled together (e.g., bonded, snap-fit, locking tabs, heated, etc.). The clamshell 402 can be made of a rigid plastic (PVC, PET, PP), paper pulp, PC, biodegradable plastics, cardboard/paperboard, and the like.

The clamshell 402 can form a portion of a screen protector installation system (e.g., screen protector installation system 100, screen protector installation system 200, screen protector installation system 300, etc.). The clamshell 402 may be placed within and affixed to an outer container (e.g., outer container 190, outer container 290, outer container 390, etc.). For example, the clamshell 402 may have a shape and/or dimensions complementary to a cavity of an outer container such that it snugly fits within the outer container. In some embodiments, the outer container is a hinged box. In such embodiments, the bottom tray portion 420 of the clamshell 402 can be adhered, or glued, into the base of the outer container. The lid portion 496 can be adhered, or glued, to the inside surface of the hinged lid of the outer container. Therefore, the bottom tray portion 420 is affixed to the outer container and the lid portion 496 is affixed to the hinged lid. In some embodiments, the lid portion 496 is adhered to an inside surface of a removable lid.

The bottom tray portion 420 can be received within the outer container. The bottom tray portion 420 can include a peripheral wall around the bottom tray portion 420 that interfaces (e.g., contacts, touches, etc.) with the cavity of the outer container. For example, the peripheral wall can have a shape and dimensions similar to the outer container such that the bottom tray portion 420 fits snugly within the cavity of the outer container and cannot move within the outer container. The peripheral wall can provide surface area along the sides of the bottom tray portion 420 to adhere the bottom tray portion 420 to the outer container. The bottom tray portion 420 may include parallel ridges, or rails, extending longitudinally along the bottom tray portion 420. The rails are configured to be received by a top tray portion (e.g. via complementary grooves, channels, recesses, etc.), such that the top tray portion overlaps at least a portion of the rails of the bottom tray portion 420. The top tray portion can slidingly move along the rails of the bottom tray portion 420, maintaining longitudinal alignment relative to one another, and adjust the distance between top tray portion and the bottom tray portion 420.

In some embodiments, the top tray portion can be affixed to the bottom tray portion and/or affixed to the outer container to hold it in a position relative to the bottom tray portion 420. In some embodiments, the bottom tray portion 420 and/or the top tray portion can include a stop feature (e.g., a wall, a protrusion, a block, etc.) that prevents/limits movement of the top tray portion past a certain position along the length of the bottom tray portion. The bottom tray portion 420 can be universal (e.g., a shared component, a common part, etc.), as the bottom tray portion 420 can be assembled with a number of different top tray portions, or in various positions relative to a top tray portion along the rails of the bottom tray portion and thereby accommodate a variety of different handheld devices of different shapes and/or sizes.

In some embodiments, the bottom tray portion 420 can be assembled with a top tray portion formed for a specific handheld device. For example, the bottom tray portion 420 can be assembled with a first top tray portion configured to align a first handheld device. The first top tray portion can have features configured to receive the rails of the bottom tray portion, and features (e.g., protrusions, projections, blocks, walls, etc.) configured to align a portion of the first handheld device when the first top tray portion is assembled with the bottom tray portion 420. The bottom tray portion 420 can also be assembled with a different second top tray portion configured to align a second handheld device. The second top tray portion can have features configured to receive the rails of the bottom tray portion, and features (e.g., protrusions, projections, blocks, walls, etc.) configured to align a portion of the second handheld device when the second top tray portion is assembled with the bottom tray portion 420. Therefore, the bottom tray portion 420 can be used across multiple handheld devices simply by varying the top tray portion

In some embodiments, the top tray portion can be set at a predetermined distance from the bottom tray portion to accommodate a specific handheld device. For example, the top tray portion can be set via a jig corresponding to the specific handheld device. Different jigs corresponding to different handheld devices can be used to easily adjust the top tray portion relative to the bottom tray portion in a set position. In some embodiments, the rails of the bottom tray portion 420 may include adjustable stops, or detents, to position the top tray portion at discreet predefined locations along the rails of the bottom tray portion. For example, the rails may include notches/steps, or visual markers, indicating where to set the top tray portion relative to the bottom tray portion 420 to accommodate the clamping of a given model of handheld device. In some embodiments, the top tray portion can be affixed to the bottom tray portion 420 and/or the outer container to secure the tray assembly in the set position.

The lid portion 496 includes a substantially flat surface on a side opposite the retaining member 498 that can be adhered to an inner surface of a lid of the outer container such that when the lid encloses the outer container, the clamshell 402 halves (the lid portion 496, the bottom tray portion 420) are folded together, enclosing the clamshell 402. In some embodiments, the lid portion 496 is the lid of the outer container. The lid portion 496 can include a retaining member 498 protruding from an inner surface of the lid portion that is functionally and/or structurally similar to the retaining member 398 of FIGS. 9-16 and the retaining member 298 of FIGS. 2-8. The retaining member serves to press against a back surface of a handheld device during installation. The lid portion 496 can be used to easily couple a retaining member 398 to a standard outer container (e.g., a hinged box). The retaining member 398 can vary in shape, dimensions, and/or configurations to accommodate different handheld devices. For example, the retaining member 398 may protrude further away from the upper surface of the lid portion 496 to contact a handheld device that is flatter, and therefore further from the lid. Different lid portions can be adhered to the same outer container to accommodate multiple handheld devices of different shapes and/or sizes.

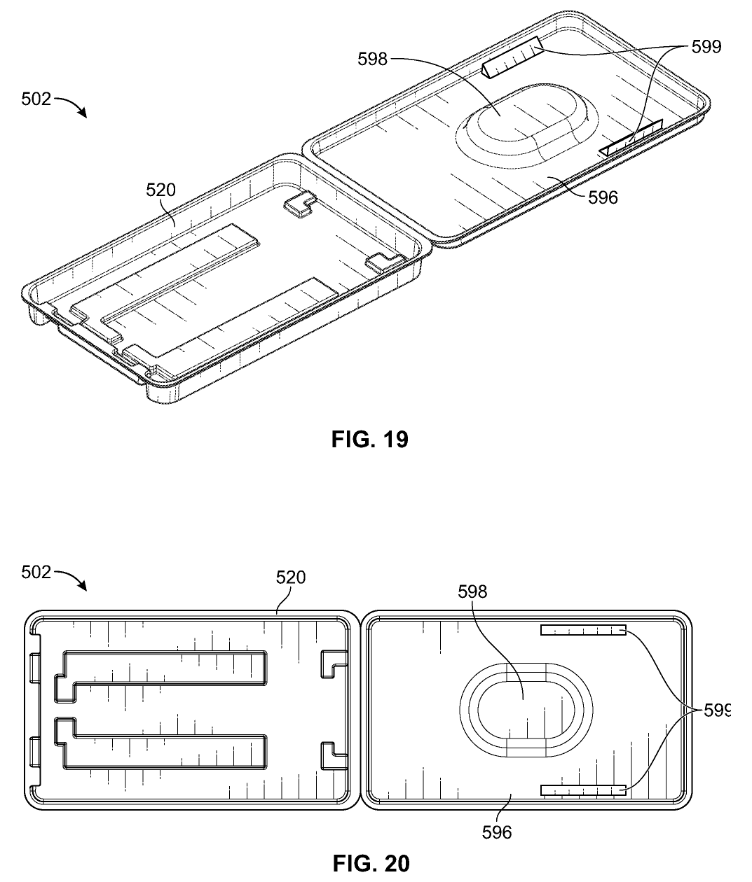

Referring generally to FIGS. 19-20, a lid portion 596 having a retaining member 598 and a bottom tray portion 520 are shown, according to some embodiments. The lid portion 596 and the bottom tray portion 520 are hingedly attached to one another, each forming a half of a clamshell 502. The clamshell 502 is functionally and./or structurally similar to the clamshell 402 of FIGS. 17-18. The clamshell 502 can form a portion of a screen protector installation system (e.g., screen protector installation system 100, screen protector installation system 200, screen protector installation system 300, etc.).The clamshell 502 may be placed within and affixed to an outer container (e.g., outer container 190, outer container 290, outer container 390, etc.). For example, the clamshell 502 may have a shape and/or dimensions complementary to a cavity of an outer container such that it snugly fits within the outer container. In some embodiments, the outer container is a hinged box. In such embodiments, the bottom tray portion 520 of the clamshell 502 can be adhered, or glued, into the base of the outer container. The lid portion 596 can be adhered, or glued, to the inside surface of the hinged lid of the outer container. Therefore, the bottom tray portion 520 is affixed to the outer container and the lid portion 596 is affixed to the hinged lid. In some embodiments, the lid portion 496 is adhered to an inside surface of a removable lid.

As shown in FIG. 19, in a fully extended open position, an upper surface of the lid portion 596 and an upper surface of the bottom tray portion 520 are substantially parallel and face upwards. In a closed (e.g., enclosed) position, the lid portion 596 and the bottom tray portion 520 are folded towards each other, and the upper surface of the lid portion 596 and the upper surface of the bottom tray portion 520 are substantially parallel and face one another. In some embodiments, the lid portion 596 and the bottom tray portion 520 each include a peripheral wall forming a flat mating face. The flat mating face of the lid portion 596 and the flat mating face of the bottom tray portion 520 at least partially contact each other when the clamshell 502 is in a closed position. The lid portion 596 and the bottom tray portion 520 may be integrally formed and folded over, or they can be coupled together (e.g., bonded, snap-fit, locking tabs, heated, etc.). The clamshell 502 can be made of a rigid plastic (PVC, PET, PP), paper pulp, PC, biodegradable plastics, cardboard/paperboard, and the like.

The bottom tray portion 520 is functionally and/or structurally similar to the bottom tray portion 420 of FIGS. 17-18. The bottom tray portion 420 forms a stationary/fixed bottom tray of a tray assembly (e.g., tray assembly 110, tray assembly 210, tray assembly 310, etc.). The bottom tray portion 520 shown in FIGS. 19-20 is functionally and/or structurally similar to the first tray portion 320 of FIGS. 9-16, the first tray portion 220 of FIGS. 2-8, and the first tray portion 120 of FIG. 1. However, in some embodiments, the bottom tray portion 520 may be functionally and/or structurally similar to the second tray portion 330 of FIGS. 9-16, the second tray portion 230 of FIGS. 2-8, and the second tray portion 130 of FIG. 1. The bottom tray portion 520 can be received within an outer container. The bottom tray portion 520 can include a peripheral wall around the bottom tray portion 520 that interfaces (e.g., contacts, touches, etc.) with the cavity of the outer container. For example, the peripheral wall can have a shape and dimensions similar to the outer container such that the bottom tray portion 520 fits snugly within the cavity of the outer container and cannot move within the outer container. The peripheral wall can provide surface area along the sides of the bottom tray portion 420 to adhere the bottom tray portion 420 to the outer container. The bottom tray portion 520 may include parallel ridges, or rails, extending longitudinally along the bottom tray portion 420. The rails are configured to be received by a top tray portion (e.g. via complementary grooves, channels, recesses, etc.), such that the top tray portion overlaps at least a portion of the rails of the bottom tray portion 520. The top tray portion can slidingly move along the rails of the bottom tray portion 520, maintaining longitudinal alignment relative to one another, and adjust the distance between top tray portion and the bottom tray portion 520.

In some embodiments, the top tray portion can be affixed to the bottom tray portion 520 and/or affixed to the outer container to hold it in a position relative to the bottom tray portion 520. In some embodiments, the bottom tray portion 520 and/or the top tray portion can include a stop feature (e.g., a wall, a protrusion, a block, etc.) that prevents/limits movement of the top tray portion past a certain position along the length of the bottom tray portion. The bottom tray portion 520 can be universal (e.g., a shared component, a common part, etc.), as the bottom tray portion 520 can be assembled with a number of different top tray portions, or in various positions relative to a top tray portion along the rails of the bottom tray portion and thereby accommodate a multiple handheld devices of different shapes and/or sizes.

In some embodiments, the bottom tray portion 520 can be assembled with a top tray portion formed for a specific handheld device. For example, the bottom tray portion 520 can be assembled with a first top tray portion configured to align a first handheld device. The first top tray portion can have features configured to receive the rails, and features (e.g., protrusions, projections, blocks, walls, etc.) configured to align a portion of the first handheld device when the first top tray portion is assembled with the bottom tray portion 520. The bottom tray portion 520 can also be assembled with a second top tray portion configured to align a second handheld device. The second top tray portion can have features configured to receive the rails, and features (e.g., protrusions, projections, blocks, walls, etc.) configured to align a portion of the second handheld device when the second top tray portion is assembled with the bottom tray portion 520. Therefore, the bottom tray portion 520 can be used across multiple handheld devices simply by varying the top tray portion

In some embodiments, the top tray portion can be set at a predetermined distance from the bottom tray portion to accommodate a specific handheld device. For example, the top tray portion can be set via a jig corresponding to the specific handheld device. Different jigs corresponding to different handheld devices can be used to easily adjust the top tray portion relative to the bottom tray portion in a set position. In some embodiments, the rails of the bottom tray portion 520 may include adjustable stops, or detents, to position the top tray portion along the rails. For example, the rails may include notches/steps, or visual markers, indicating where to set the top tray portion relative to the bottom tray portion 520. In some embodiments, the top tray portion can be affixed to the bottom tray portion 520 and/or the outer container to affix the tray assembly in the set position.

The lid portion 596 is functionally and/or structurally similar to the lid portion 496 of FIGS. 17-18. The lid portion 596 includes a substantially flat surface on a side opposite the retaining member 598 that can be adhered to an inner surface of a lid of the outer container such that when the lid encloses the outer container, the clamshell halves (the lid portion 596, the bottom tray portion 520) are folded together, enclosing the clamshell 502. In some embodiments, the lid portion 596 is the lid of the outer container. The retaining member 598 may protrude from an inner surface of the lid portion 596. The retaining member 598 is functionally and/or structurally similar to the retaining member 398 of FIGS. 9-16 and the retaining member 298 of FIGS. 2-8.. The retaining member 598 serves to press against a back surface of a handheld device when the outer container is closed during installation. When the lid portion 596 closes, the retaining member 598 extends into the cavity of the outer container to press against a handheld device. The lid portion 596 can be used to easily couple a retaining member 598 to a standard outer container (e.g., a hinged box), by affixing the lid portion 596 to an inner surface of a standard outer container lid. The retaining member 598 can vary in shape, dimensions, and/or configurations to accommodate different handheld devices. For example, the retaining member 598 may protrude further away from the upper surface of the lid portion 596 to contact a handheld device that is flatter, and therefore further from the lid portion 596. Different lid portions can be adhered to the same outer container to accommodate multiple handheld devices of different shapes and/or sizes.

When a top tray portion is positioned in the clamshell 502 above the bottom tray portion 520, the bottom tray portion 520 and the top tray portion form a tray assembly (e.g., tray assembly 110, tray assembly 210, tray assembly 310, etc.) that can be used to align a handheld device during use of a screen protector installation system (e.g., screen protector installation system 100, screen protector installation system 200, screen protector installation system 300, etc.). The respective tray portions, as discussed above with respect to FIGS. 1-16, contact the handheld device to properly align the handheld device, restricting movement in a number of directions. The clamshell 502 includes at least one side bar 599 to aid in laterally aligning the handheld device within the tray assembly.

The at least one side bar 599 is disposed proximate a lateral edge of the lid portion 596 and extends away from an inner surface of the lid portion 596. The at least one side bar 599 may be coupled to the lid portion 596 or integrally formed with the lid portion 596. In some embodiments, as shown in FIGS. 19-20, the at least one side bar 599 is a pair of side bars disposed on opposite sides of the retaining member 598. While FIGS. 19-20 show the at least one side bar 599 within a lid portion 596 of the clamshell 502, the at least one side bar 599 can be coupled to a lid (e.g., lid 396, lid 296, etc.) of an outer container used in a screen protector installation system (e.g., screen protector installation system 100, screen protector installation system 200, screen protector installation system 300, etc.) that encloses the outer container prior to installation. The lid can be used to press a retaining member (e.g., retaining member 598, retaining member 498, retaining member 398, retaining member 298, etc.) against a back surface of a handheld device. The at least one side bar 599, similar to a retaining member, extends into the cavity of an outer container and applies a downward force onto the handheld device. The at least one side bar 599 applies pressure to a side edge of the handheld device, providing an additional lateral alignment mechanism to precisely align the handheld device during installation. For example, a handheld device may become askew (off-center, tilted) within a tray assembly, and when the at least one side bar 599 moves downward towards the handheld device, the angled surface of the side bar 599 makes contacts with the sides of the handheld device. The angled surface of the side bar 599 applies a gradual force against the side of the handheld device, pushing the handheld device into proper alignment for correct attachment of the screen protector to the device screen 16.

The at least one side bar 599 extends parallel to a longitudinal axis of the tray assembly, and is disposed on a side of the lid portion 596 such that when the lid portion 596 is closed (e.g., folding the clamshell 502 closed), the at least one side bar 599 comes into direct contact with the handheld device, pressing against the sides of the handheld device, thereby guiding it into an aligned position with the screen protector assembly to be installed thereon. The at least one side bar 599 may extend along at least a portion of the length of the lid portion 596 and can be positioned proximate a midpoint of a tray assembly, or proximate one end of the tray assembly. The angled surface of the at least one side bar 599 is inclined at an angle (e.g., 5 degrees, 10 degrees, 15, degrees, 20 degrees, 25 degrees, 30 degrees, 35 degrees, 45 degrees, 50 degrees, 60 degrees, etc.) that guides the handheld device into lateral (e.g., relative to the longitudinal axis of a tray assembly) alignment for installation. Improved lateral alignment can further ensure alignment with the tray assembly 110. The at least one side bar 599 can be wedge-shaped (e.g., slanted, or tapered at an angle relative to the inner surface of the lid portion 496), with an angled surface configured to contact the side edges of the handheld device. The wedge shape allows for application of an incremental and controlled force onto the handheld device pushing it into alignment. In some embodiments the dimensions (e.g., angle, width, length, depth) of the at least one side bar 599 can be selected based on a selected range of handheld devices. The at least one side bar 599 can further aid in holding the handheld device down during installation to ensure proper alignment.

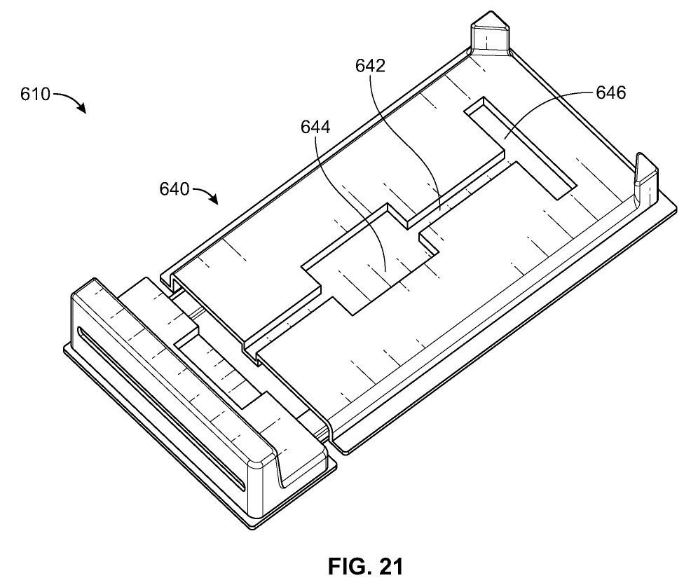

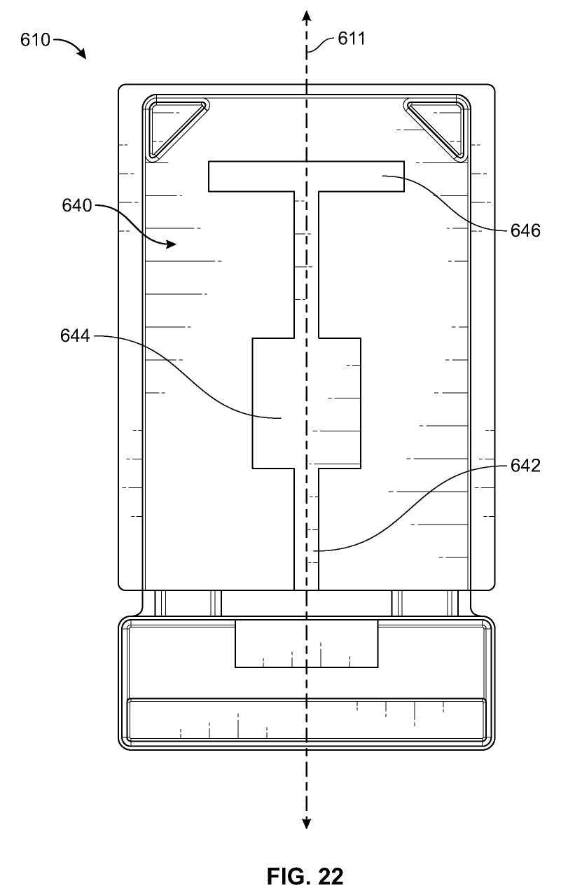

Referring generally to FIGS. 21-25, a tray assembly 610 including a tray keying feature 640, and a complementary screen protector keying feature 670 for a screen protector assembly (e.g., screen protector assembly 160, screen protector assembly 260, screen protector assembly 360,etc.), are shown, according to some embodiments. The tray assembly 610 is functionally and/or structurally similar to the tray assembly 310 of FIGS. 9-16, tray assembly 210 of FIGS. 2-8, and the tray assembly 110 of FIG. 1. While the tray keying feature 640 shown in the embodiment depicted in FIGS. 21-22 is disposed on one tray portion of the tray assembly 610, in alternate embodiments the tray keying feature 640 may be provided on one or more tray portions without departing from the scope of the present disclosure. In some embodiments, the tray keying feature 640 can be provided on a tray portion functionally and/or structurally similar to the first tray portion 320 of FIGS. 9-16, the first tray portion 220 of FIGS. 2-8, and the first tray portion 120 of FIG. 1. In some embodiments, the tray keying feature 640 can be provided on a tray portion functionally and/or structurally similar to the second tray portion 330 of FIGS. 9-16, the second tray portion 230 of FIGS. 2-8, and the second tray portion 130 of FIG. 1.

Referring again to FIG. 22, the tray keying feature 640 is configured to align a screen protector assembly to the tray assembly 610. The tray keying feature 640 is functionally and/or structurally similar to the tray keying feature 240 of FIGS. 2-8 and the tray keying feature 140 of FIG. 1. The tray keying feature 640 is arranged such that the screen protector assembly can be positioned in the tray assembly 610 and engage the tray keying feature 640 to align the screen protector assembly. Referring to FIGS. 21-22, the tray keying feature 640 includes a channel portion 642, a central recess 644, and a T-shaped portion 646. The tray keying feature 640 is recessed into a top surface of the tray assembly 610. In some embodiments, the tray keying feature 640 is recessed at a uniform depth, and in some embodiments, the tray keying feature 640 has variable depths. In some embodiments, the tray keying feature 640 is molded into the tray assembly 610.

Referring still to FIG. 22, the channel portion 642 runs along a central longitudinal axis 611 of the tray assembly 610. The channel portion 642 can run along a portion of a length of the tray assembly 610. The channel portion 642 is formed as a linear groove or recess that extends along a length of the tray assembly 610. The channel portion 642 defines a path for the screen protector keying feature 670, ensuring that the screen protector keying feature 670 is aligned and positioned correctly. The channel portion 642 provides a guide to laterally align screen protector assembly accurately along a specific direction or plane and restricts lateral or angular movement of the screen protector assembly, ensuring proper positioning and alignment of the screen protector assembly to the tray assembly 610. The channel portion 642 prevents lateral movement or misalignment relative to the longitudinal axis 611 of the tray assembly 610. The channel portion 642 is configured to receive the screen protector keying feature 670 snugly to prevent any undesired movement (e.g. lateral movement, and/or rotational or angular movement). In some embodiments, the channel portion 642 has tapered walls to facilitate positioning of the screen protector keying feature 670. The central recess 644 is centered along the longitudinal axis 611 of the tray assembly 610 and is disposed at a point along the channel portion 642. The central recess 644 may be disposed proximate a center of the tray assembly 610. In some embodiments, the central recess 644 may be disposed proximate an end of the tray assembly 610. The central recess 644 is a rectangular or square recess having walls parallel to the longitudinal axis 611 of the tray assembly 610 that are configured to restrict lateral movement. In some embodiments, the central recess 644 is a different polygonal shape (e.g., a triangle, an octagon, a hexagon, etc.). The size and/or shape of the central recess 644 can be adjusted to accommodate different handheld devices.

The T-shaped portion 646 of the tray keying feature 640 is disposed at a distal end of the channel portion 642. The T-shaped portion 646 extends perpendicular to the channel portion 642 and the longitudinal axis 611 of the tray assembly 610. The T-shaped portion 646 defines an endpoint of the tray assembly 610 and restricts longitudinal movement of the screen protector keying feature 670 and the screen protector assembly attached thereto. The T-shaped portion 646 can aid in longitudinally aligning the screen protector keying feature 670 (and the screen protector assembly attached thereto) within the tray keying feature 640 of the tray assembly 610.

The channel portion 642, the central recess 644, and the T-shaped portion 646 restrict movement of the screen protector keying feature 670 (and the screen protector assembly attached thereto) in multiple directions at different points within the footprint of the tray assembly 610. The combination of the channel portion 642, the central recess 644, and the T-shaped portion 646, form a distinctive geometry that ensures precise and accurate alignment, and securely locks the screen protector keying feature 670 (and the screen protector assembly attached thereto) in place in the tray assembly 610. Further, the shape prevents the screen protector keying feature 670 from being installed incorrectly, helping to prevent any potential user error. In some embodiments, at least one of the channel portion 642, the central recess 644, and the T-shaped portion 646 can be used to align the tray assembly 610 to an outer container (e.g., outer container 190, outer container 290, outer container 390, etc.). For example, the central recess 644 can align the tray assembly 610 to an outer container.

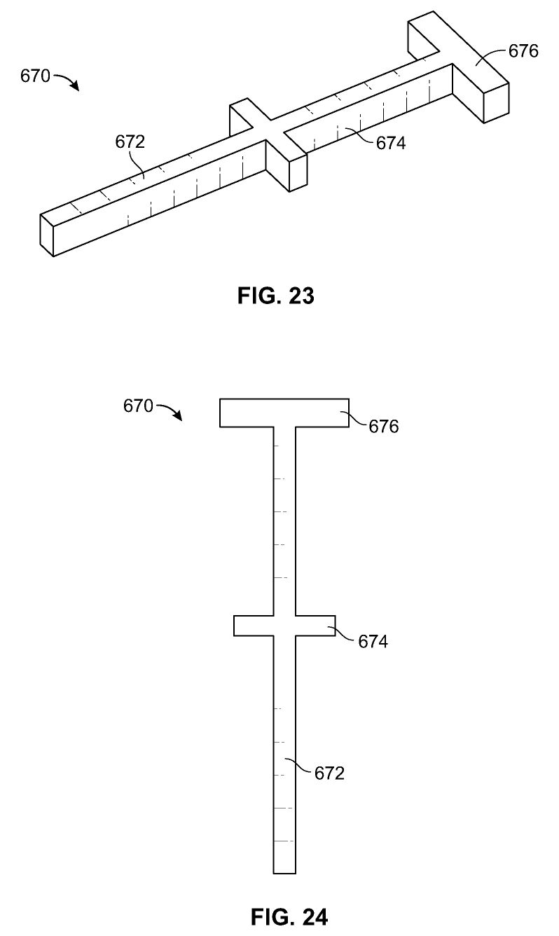

Referring to FIGS. 23-24, the screen protector keying feature 670 is configured to be complementary to the tray keying feature 640 (e.g., the screen protector keying feature 670 has dimensions and/or geometry matching the dimensions and/or geometry of the tray keying feature 640 such that it can be aligned and oriented within the tray keying feature 640). The screen protector keying feature 670 is configured to be received within the tray keying feature 640. The screen protector keying feature 670 is configured to couple to a cap sheet of a screen protector assembly and align the screen protector assembly within the tray assembly 610 via engagement with the tray keying feature 640. Further, the screen protector keying feature 670, during installation, applies pressure to the screen protector to aid in applying the screen protector and reducing air bubbles. In some embodiments, the screen protector keying feature 670 is glued into the tray keying feature 640.

The screen protector keying feature 670 includes a central rib 672 running along a length of the screen protector keying feature 670, a first crossbar 674, and a second crossbar 676 at a distal end of the central rib 672.The central rib 672 is a straight protrusion that is configured to be received within the channel portion 642 of the tray keying feature 640. The central rib 672 has a rectangular or square cross-section matching the shape of the channel portion 642. When coupled to a cap sheet, the central rib 672 runs along a longitudinal axis 611 of the screen protector assembly. The central rib 672 provides longitudinal alignment, preventing any lateral movement within the tray keying feature 640. The central rib 672 may have a length that is less than, similar to, or greater than a length of the channel portion 642.

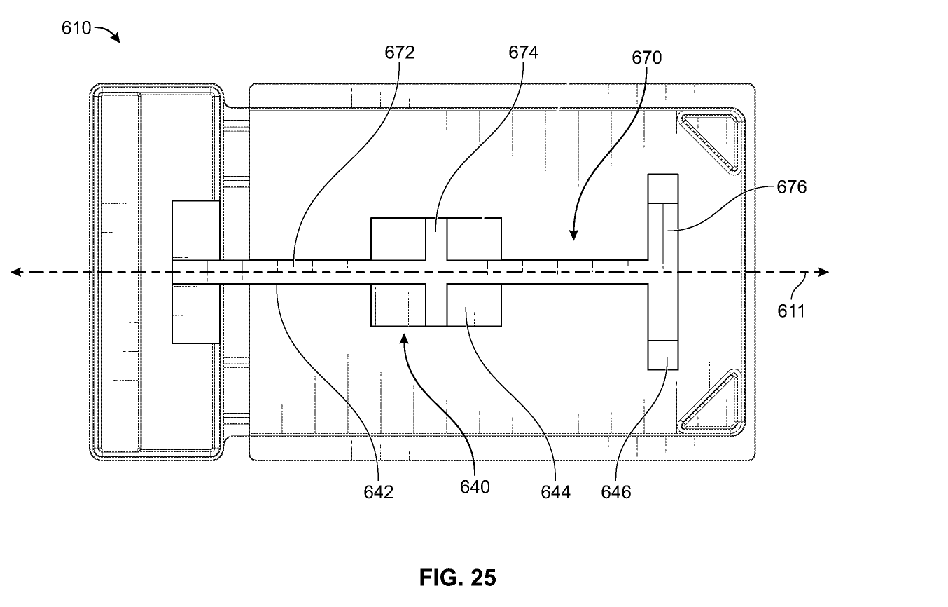

The first crossbar 674 is positioned along the central rib 672 and centered on the central rib 672. For example, as shown in FIG. 25, the first crossbar 674 can be positioned proximate a midpoint of the central rib 672. In some embodiments, the first crossbar 674 is positioned such that it is proximate a center point of the tray assembly 610. The first crossbar 674 extends perpendicular to the central rib 672. The first crossbar 674 is configured to be received within the central recess 644 of the tray keying feature 640. The first crossbar 674 is positionable within the central recess 644 and prevents lateral or angular movement. As shown in FIG. 25, the first crossbar 674 can be positioned at various points along a length of the central rib 672 and be received by the central recess 644.

The second crossbar 676 is positioned along and centered on the central rib 672. The second crossbar 676 is positioned at the distal end of the central rib 672 and spaced apart from the first crossbar 674. The second crossbar 676 extends perpendicular to the central rib 672. The second crossbar 676 is configured to be received within the T-shaped portion 646 of the tray keying feature 640 and prevent lateral or angular movement. The second crossbar 676 further provides a stop that holds the screen protector keying feature 670 in place. While the second crossbar 676 in FIGS. 23-25 is wider than the first crossbar 674, in some embodiments, the second crossbar 676 can be equal to, or less than the width of the first crossbar 674. The second crossbar 676 can have a width similar to, or less than the width of the T-shaped portion 646.

As shown in FIG. 25, the screen protector keying feature 670 is received within the tray keying feature 640 and locked into place. The central rib 672 is positioned within the channel portion 652 of the tray keying feature 640, centering the central rib 672 along the longitudinal axis 611 of the tray assembly 610 and preventing any lateral movement. The first crossbar 674 is positioned within the central recess 644 of the tray keying feature, further restricting lateral movement. The second crossbar 676 is received within the T-shaped portion 646, preventing any longitudinal movement. The screen protector keying feature 670, through the central rib 672, the first crossbar 674, and the second crossbar 676, ensures a secure fit that prevents movement, rotation, or dislodging, during installation. Thus, the screen protector assembly can be easily, and precisely aligned. Further, as a screen protector assembly is installed, the screen protector keying feature 670 applies a line of pressure along the middle of the screen protector assembly along the longitudinal axis 611 via the central rib 672, the first crossbar 674 applies pressure laterally proximate the midpoint the screen protector assembly, and the second crossbar 676 applies pressure laterally proximate an end of the screen protector assembly. This distribution of pressure aids in more uniformly evacuating or preventing air bubbles between the device screen and the screen protector, as air is removed from the center of the screen protector assembly and out towards the edges of the screen protector assembly.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A screen protector installation system for a handheld device, comprising:
a tray assembly defining a longitudinal axis and having a first peripheral edge at a first end and a second peripheral edge at a second end opposite the end, the tray assembly comprising:
a first tray portion disposed at the first end comprising a first projection extending from the first peripheral edge defining a first locating plane configured to abut an edge of the handheld device;
a second tray portion disposed at the second end comprising a second projection extending from the second peripheral edge defining at least one second locating plane configured to abut an end of the handheld device opposite the edge;
a tray keying feature; and
a slot extending through a wall of one of the first projection or the second projection;
wherein:
the first tray portion and the second tray portion are configured to telescope along the longitudinal axis,
the first locating plane and the second locating plane define a hollow region within the tray assembly configured to align the handheld device; and
a screen protector assembly configured to be received within the tray assembly, the screen protector assembly comprising:
a screen protector having an adhesive layer configured to attach to a screen of the handheld device and a liner removably coupled to the adhesive layer;
a cap sheet removably coupled to the screen protector opposite the liner;
a screen protector keying feature coupled to the cap sheet configured to engage the tray keying feature and align the screen protector assembly to the tray assembly; and
a pull tab coupled to a coupling end of the liner configured to extend longitudinally over the liner and through the slot of the tray assembly, wherein pulling the pull tab through the slot peels the liner off the adhesive layer, exposing the adhesive layer.

2. The screen protector installation system of claim 1, wherein:
the first projection is a block and the first locating plane is defined by a surface of the block perpendicular to the longitudinal axis; and
the second projection is a pair of angled blocks mirrored across the longitudinal axis and the second locating plane is a pair of second locating planes, each second locating plane defined by a surface extending between the second peripheral edge and a lateral edge of the tray assembly.

3. The screen protector installation system of claim 2, wherein the slot extends through the block.

4. The screen protector installation system of claim 1, wherein one of the first tray portion or the second tray portion is slidingly moveable with respect to the other of the first tray portion or the second tray portion.

5. The screen protector installation system of claim 1, wherein one of the first tray portion or the second tray portion includes at least one ridge extending parallel to the longitudinal axis and the other of the first tray portion or the second tray portion includes a groove configured to receive the at least one ridge to move along a length of the at least one ridge.

6. The screen protector installation system of claim 1, wherein the tray keying feature is a central channel extending longitudinally through one of the first tray portion or the second tray portion and the screen protector keying feature is a rib configured to be received within the central channel.

7. The screen protector installation system of claim 6, wherein the rib is adhered to the central channel.

8. The screen protector installation system of claim 1, further comprising:
an outer container comprising sidewalls defining an opening and a cavity configured to receive the tray assembly, the screen protector assembly, and the handheld device;
a lid removably coupled to the outer container and enclosing the outer container in a closed position; and
a retaining member coupled to an inner surface of the lid configured to extend into the cavity and secure the handheld device in the closed position.

9. The screen protector installation system of claim 8, wherein:
the tray assembly is disposed in the outer container such that the slot aligns with the opening;
the screen protector assembly is arranged such that the coupling end is opposite the slot; and
the pull tab passes through the slot and the opening.

10. The screen protector installation system of claim 8, wherein:
the tray assembly is disposed in the outer container such that the slot is opposite the opening;
the screen protector assembly is arranged such that the coupling end is opposite the slot; and
the pull tab passes through the slot, beneath the tray assembly, and through the opening.

11. The screen protector installation system of claim 8, wherein one of the first tray portion or the second tray portion is molded into the outer container.

12. A screen protector installation system for a handheld device, comprising:
a tray assembly defining a longitudinal axis and having a first peripheral edge at a first end and a second peripheral edge at a second end opposite the first end, the tray assembly comprising:
a first tray portion disposed at the first end comprising a first projection extending from the first peripheral edge defining a first locating plane configured to abut an edge of the handheld device;
a second tray portion disposed at the second end comprising a second projection extending from the second peripheral edge defining a second locating plane configured to abut an end of the handheld device opposite the edge;
a tray keying feature; and
a slot extending through a wall of one of the first projection or the second projection;
wherein:
the first locating plane and the second locating plane define a hollow region within the tray assembly to align the handheld device,
the first tray portion and the second tray portion are configured to telescope along the longitudinal axis, and
one of the first tray portion or the second tray portion is slidingly moveable along a length of the other of the first tray portion or the second tray portion to adjust a size of the hollow region; and
a screen protector assembly, comprising:
a screen protector having an adhesive layer configured to attach to a screen of a handheld device and a liner removably coupled to the adhesive layer;
a cap sheet removably coupled to the screen protector opposite the liner;
a screen protector keying feature configured to engage the tray keying feature and align the screen protector assembly to the tray assembly; and
a pull tab coupled to a coupling end of the liner configured to extend longitudinally over the liner and through the slot, wherein pulling the pull tab through the slot peels the liner off the adhesive layer, exposing the adhesive layer.

13. The screen protector installation system of claim 12, further comprising set positions along the length of the other of the first tray portion or the second tray portion, each set position associated with a range of dimensions that may be received in the hollow region.

14. The screen protector installation system of claim 12, wherein:
the first projection is a block and the first locating plane is defined by a surface of the block perpendicular to the longitudinal axis; and
the second projection is a pair of angled blocks mirrored across the longitudinal axis and the second locating plane is a pair of second locating planes, each second locating plane defined by a surface extending between the second peripheral edge and a lateral edge of the tray assembly.

15. The screen protector installation system of claim 14, wherein each second locating plane is tangent to a border of the handheld device.

16. The screen protector installation system of claim 12, wherein:
the tray keying feature is a central channel extending longitudinally through the tray assembly; and
the screen protector keying feature is a rib configured to be received within the central channel and facilitate removal of the cap sheet from the screen protector.

17. A screen protector installation system for a handheld device, comprising:
an outer container comprising side walls defining an opening and a cavity;
a tray assembly disposed within the cavity defining a longitudinal axis and having a first peripheral edge at a first end and a second peripheral edge at a second end opposite the first end, the tray assembly comprising:
a first tray portion disposed at the first end comprising a first projection extending from the first peripheral edge defining a first locating plane configured to abut an edge of the handheld device when the handheld device is in an aligned position;
a second tray portion disposed at the second end comprising a second projection defining a second locating plane configured to abut an end of the handheld device opposite the edge when the handheld device is in the aligned position;
wherein one of the first tray portion or the second tray portion is a moving tray and the other of the first tray portion or the second tray portion is a stationary tray;
a tray keying feature; and
a slot extending through a wall of the moving tray and configured to be positioned opposite the opening,
wherein:
the first projection and the second projection define a hollow region within the tray assembly configured to receive and align the handheld device; and
the moving tray is slidingly moveable relative to the stationary tray along the longitudinal axis along a length of the stationary tray; and
a screen protector assembly, comprising:
a screen protector having an adhesive layer configured to attach to a screen of a handheld device and a liner removably coupled to the adhesive layer;
a cap sheet removably coupled to the screen protector opposite the liner;
a screen protector keying feature coupled to the cap sheet and configured to engage the tray keying feature and align the screen protector assembly to the tray assembly; and
a pull tab coupled to the liner at a coupling end configured to be positioned adjacent the opening, the pull tab configured to extend longitudinally over the liner through the slot, beneath the tray assembly, and through the opening,
wherein:
pulling the pull tab through the opening draws the moving tray towards the stationary tray along the longitudinal axis against the handheld device until the handheld device is in the aligned position, and
when the handheld device is in the aligned position, the pull tab is configured to be pulled through the opening to peel the liner off the adhesive layer, exposing the adhesive layer.

18. The screen protector installation system of claim 17, wherein:
the first projection is a block and the first locating plane is defined by a surface of the block perpendicular to the longitudinal axis; and
the second projection is a pair of angled blocks mirrored across the longitudinal axis and the second locating plane is a pair of second locating planes, each second locating plane defined by a surface extending between the second peripheral edge and a lateral edge of the tray assembly.

19. The screen protector installation system of claim 17, wherein each second locating plane is tangent to a border of the handheld device.

20. The screen protector installation system of claim 17, further comprising a groove in a lower surface of the tray assembly along the longitudinal axis, wherein the pull tab is configured to be pulled within the groove.
